(19) United States
(12) Patent Application Publication
(10) Pub. No.: US 2026/0319792 A1
(43) Pub. Date: Oct. 15, 2026

(54) AI-GENERATED DASHBOARDS

(71) Applicant: AlertD Inc., Walnut Creek, CA (US)

(72) Inventor: Geoffrey Hendrey, San Anselmo, CA (US)

(21) Appl. No.: 19/467,548

(22) Filed: Feb. 2, 2026

Related U.S. Application Data
(60) Provisional application No. 63/753,255, filed on Feb. 3, 2025.

(51) Int. Cl. G06F 8/77; G06F 9/451; G06N 3/0475

(52) U.S. Cl. CPC G06F 8/77; G06F 9/451; G06N 3/0475

(57) ABSTRACT

Site reliability systems and methods are described. One aspect includes receiving a plurality of signals associated with a computing system running one or more instances of a software, and analyzing the plurality of signals. A situational awareness snapshot may be presented to a user regarding a state of a system comprising the computing system and the software. A signal triage analysis related to any signals of the plurality of signals that can cause problems with an operation of the system, or are most relevant for the user to comprehend the state of the system may be presented.

This application claims the priority benefit of provisional patent application No. 63/753,255 titled “Site Reliability System and Method” filed on Feb. 3, 2025, the disclosure of which is incorporated by reference herein in its entirety.

### BACKGROUND

### Technical Field

The systems and methods described herein relate to software development lifecycle (SDLC) event and other software-related analysis, to provide system health status information and fault identification, and reduce system downtime.

### Background Art

Computing system complexity is continuously increasing, both with respect to hardware architecture and software architecture. With respect to software, SDLC events are key to a site reliability engineer's (SRE's) ability to understand problems in complex microservices or cloud-native environments. Due to the large and ever-increasing number of SDLC signals in contemporary computing systems, and MELT—and their corresponding volume, velocity, and variety, effective correlation is increasingly difficult for humans. This has led to increased downtime of computing systems year over year, resulting in reduced, rather than increased, site reliability over time.

### SUMMARY

Aspects of the invention are directed to computing systems and computing system products configured to help improve site reliability. One aspect includes a computing system receiving a plurality of signals associated with the computing system running one or more instances of a software. The signals may be analyzed using at least one trained artificial intelligence model. Based on the analyzing, the computing system may present a situational awareness snapshot to a user regarding a state of a system comprising the computing system and the software, and a signal triage analysis related to any signals of the plurality of signals that can cause problems with an operation of the system, or are most relevant for the user to comprehend the state of the system.

The computing system may provide the user with one or more alerts corresponding to any existing problems associated with the system, along with identified root causes of the existing problems, and instructions for the user regarding problem solving steps for the existing problems. The computing system may identify leading indicators of the existing problems and building proactive alerting rules to improve response time.

In an aspect, the signals include any combination of software development lifecycle (SDLC) signals associated with one or more SDLC events, one or more command log sets from one or more audit systems, and one or more metrics from one or more metric systems.

In an aspect, the SLDC signals are processed using a plurality of sliding windows. This processing may further comprise scoring and ranking each SLDC event in each sliding window using a large language model (LLM). The scoring and ranking may further comprise assigning a score between 0 and 1 to each SLDC event, with the score being based on a relative importance of the SLDC event. Each SLDC event may be color-coded and prioritized based on the score. A set of color-coded and prioritized SLDC events may be displayed to the user.

One aspect includes determining whether a score for each SLDC event is greater than a calculated median value for a set of SLDC events within a given sliding window. If the score for the SLDC event is not greater than the calculated median value, the SLDC event is not included in the set of color-coded and prioritized events. If the score for the SLDC event is greater than the calculated median value, the SLDC event is included in the set of color-coded and prioritized events, the set of color-coded and prioritized events is stored in a vector database, and the event is promoted to a next-level sliding window. In one aspect, the vector database is a retrieval-augmented generation (RAG) database.

The SLDC signals are processed by a Slack system prior to the analyzing. The audit systems may include any combination of Amazon Web Services (AWS) Cloudflare and a Kubernetes Audit Log. The metric systems may include any combination of Amazon CloudWatch, Google Cloud Monitoring and Microsoft Azure Monitoring.

The computing system may include a browser-based interface configured to enable communicating results of the analyzing with the user.

In an aspect, each signal is generated by an event associated with the system, with an event being received by the system by any of a Slack ingestion workflow, a CloudTrail ingestion workflow, and a Kubernetes audit log ingestion workflow.

Other aspects include apparatuses that implement the above methods.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIGS. 1A and 1B are block diagrams depicting a computing system architecture interface.

FIGS. 2A and 2B are block diagrams depicting a computing system architecture.

FIG. 3 is a flow diagram depicting a method to process a query.

FIG. 4 is a block diagram of a computer system architecture configured to process a query.

FIG. 5 is a screenshot of a user interface.

FIG. 6 is a screenshot of a user interface.

FIG. 7 is a screenshot of a user interface.

FIG. 8 is a data flow diagram depicting a sliding window data processing.

FIG. 9 is a data flow diagram depicting a sliding window data processing.

FIG. 10 is a data flow diagram depicting a sliding window data processing.

FIG. 11 is a screenshot of a user interface.

FIG. 12 is a screenshot of a user interface.

FIGS. 13A, 13B and 13C are screenshots of user interfaces.

FIG. 14 is a block diagram depicting a computer architecture configured to process a plurality of inputs.

FIG. 15 is a block diagram depicting a computer architecture configured to process a user input.

FIG. 16 is a schematic diagram illustrating a template lifecycle.

FIG. 17 is a schematic diagram illustrating a natural language chat interface.

FIG. 18 is a block diagram depicting a computer architecture that includes a conversational chat agent.

FIG. 19 is a block diagram depicting a user interaction with a chat agent.

FIG. 20 is a block diagram depicting a computing system.

FIG. 21 is a block diagram depicting a computer architecture configured to perform a correlation operation.

FIG. 22 is a screenshot depicting a dashboard.

FIGS. 23A through 23D are screenshots of example events.

FIGS. 24A and 24B are screenshots of a synthetic runbook.

FIG. 25 is a screenshot depicting a synthesized monitoring and alerting plan.

FIG. 26 is a screenshot depicting individual synthesized health rules.

FIG. 27 is a screenshot depicting a subway view.

FIG. 28 is a screenshot depicting a subway view.

FIG. 29 is a screenshot depicting a health rules overview showing a runbook in progress.

FIG. 30 is a screenshot depicting a design concept for chop time.

### DETAILED DESCRIPTION

In the following description, reference is made to the accompanying drawings that form a part thereof, and in which is shown by way of illustration specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random-access memory (RAM) device, a read-only memory (ROM) device, an erasable programmable read-only memory (EPROM or Flash memory) device, a portable compact disc read-only memory (CDROM), an optical storage device, a magnetic storage device, and any other storage medium now known or hereafter discovered. Computer program code for carrying out operations of the present disclosure may be written in any combination of one or more programming languages. Such code may be compiled from source code to computer-readable assembly language or machine code suitable for the device or computer on which the code can be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which includes one or more executable instructions for implementing the specified logical function(s). It is also noted that each block of the block diagrams and/or flow diagrams, and combinations of blocks in the block diagrams and/or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks.

Aspects of the systems and methods described herein are related to improving site reliability by reducing computing system downtime are disclosed. One embodiment uses Large Language Models (LLMs) to correlate SDLC events and other software system events (also referred to herein as “signals”) with traditional observability (e.g., olly) metrics, events, logs and traces (e.g., MELT). The systems and methods described herein can be configured to function as an “always on” SRE for:

Situational Awareness—Explain the state of complex microservices and cloud-native deployments.

Signal Triage—determine which signals, of thousands of available signals, are most relevant to assist the SRE in comprehending the current system state.

Root Cause Analysis—identify and alert on the causes of problems.

Runbook Synthesis—synthesize “runbooks” that instruct human users on how to resolve problems, while reducing the intensive labor associated with traditional SRE-curated runbooks.

Alert Synthesis—identify leading indicators of problems and build proactive alerting rules to improve response time.

Alerting—deliver timely and proactive alerts with clearly identified root causes.

Some aspects of the systems and methods described herein include a backend event ingestion architecture and an associated frontend user interface, both of which make use of LLMs and agentic workflows.

Some aspects of the systems and methods described herein may be configured to diagnose and explain a serious problem associated with a software or and SLDC, and select a specific set of metrics from thousands of metrics, to present for correlation use color coding, and temporal correlation to clearly pull signal from noise identify specific root causes, while providing an interactive chat session for a user with an agentic SRE.

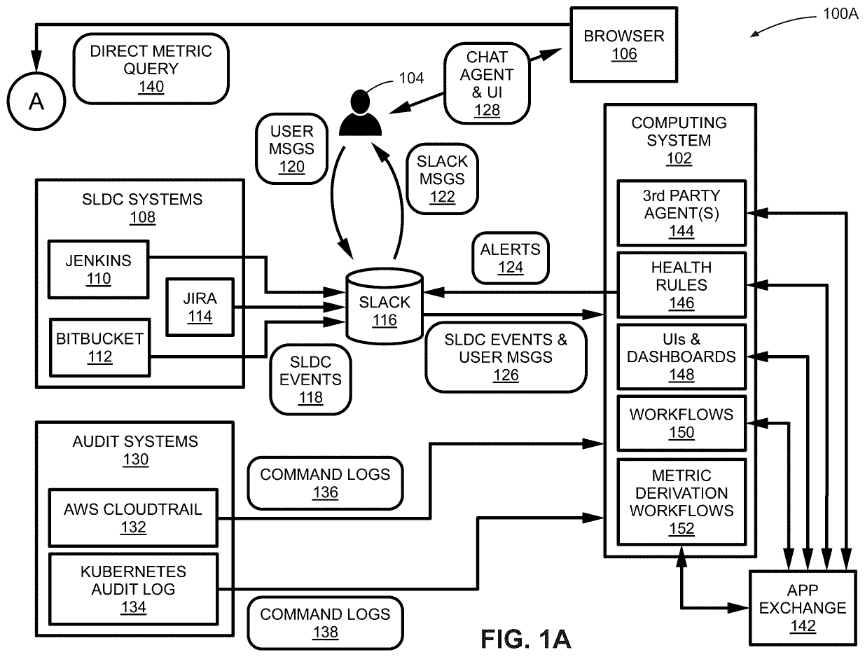

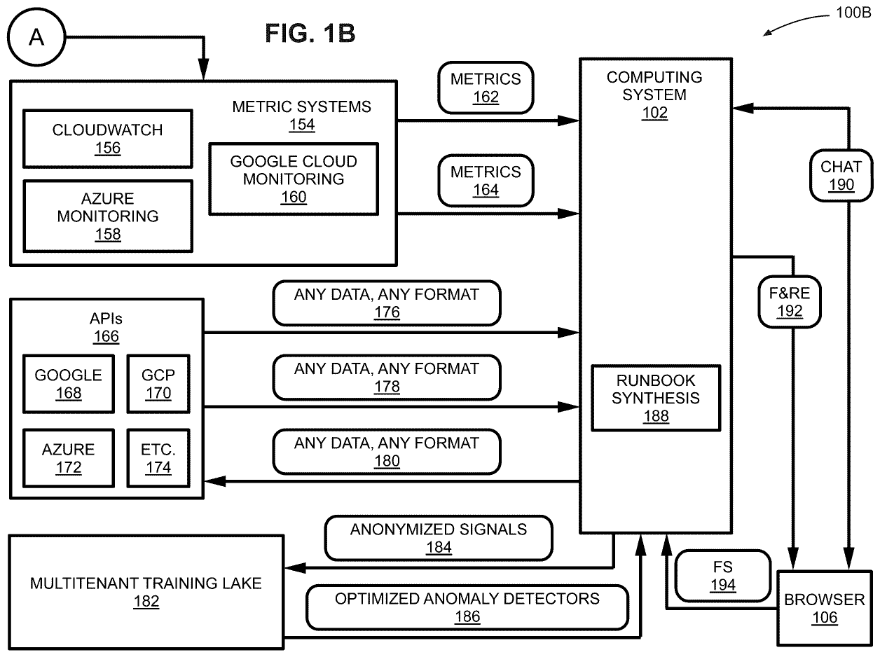

FIG. 1A is a block diagram depicting a computing system architecture interface 100A. As depicted, interface 100A includes a computing system 102, a browser 106, one or more SLDC systems 108, one or more audit systems 130, a Slack system/server 116, and an app exchange 142. Computing system 102 further includes 3^{rd} party agents 144, health rules 146, UIs & dashboards 148, workflows 150, and metric derivation workflows 152. SLDC systems 108 further includes Jenkins 110, Bitbucket 112, and JIRA 114. Audit systems 130 further includes Amazon Web Services (AWS) CloudTrail 132, and Kubernetes audit log 134.

In an embodiment, audit systems 130 is any combination of one or more systems like Kubernetes Audit Logs or CloudTrail that records the commands sent by the system (e.g., the Kubernetes system or the AWS API system).

In general audit systems 130 is/are associated with:
metrics
logging (generally logs of systems and applications)
audit logs (generally logs of control commands)
traces

In an aspect, a user 104 can interact with browser 106 via a chat agent and user interface 128. User 104 can also input one or more user messages 120 to Slack system 116. Slack system 116 may also be configured to receive one or more SLDC events 118 (e.g., SLDC signals) from SLDC systems 108. Slack system 116 may forward the SLDC events 118 and user messages 120 to computing system 102 (126). Computing system 102 may also receive command logs 136 and command logs 138 from AWS CloudTrail 132 and Kubernetes audit log 134, respectively. Computing system 102 may be configured to process SLDC events & user messages 126, command logs 136, command logs 138, and other signals (described subsequently), and output alerts 124 to Slack system 116. In a particular embodiment, alerts 124 are generated by health rules 146. Slack system 116 may communicate alerts 124 and other messages generated by computing system 102 to user 104 as Slack messages 122.

In an aspect, app exchange 142 interfaces with each of 3^{rd} party agents 144, health rules 146, UIs & dashboards 148, workflows 150, and metric derivation workflows 152.

FIG. 1B is a block diagram depicting a computing system architecture interface 100B. As depicted, interface 100B includes computing system 102, browser 106, metric systems 154, application programming interfaces (APIs) 166, and a multitenant training lake 182. Metric systems 154 further include CloudWatch 156, Azure monitoring 158, and Google cloud monitoring 160. APIs 166 further include Google 168, GCP 170, Azure 172, and other APIs (etc. 174). Computing system 102 also includes runbook synthesis 188.

In aspect, metric systems 154, APIs 166, and browser 106 generate additional signals that are processed by computing system 102 (e.g., in addition to SLDC events and user messages 126, command logs 136, and command logs 138), to generate alerts 124. Specifically, metric systems generate metrics 162 and metrics 164 that are received by computing system 102. APIs 166 generate data sets in different formats, denoted as any data, any format (ADAF) 176, and any data, any format (ADAF) 178. Computing system 102 may also send data back to APIs 166, as any data, any format (ADAF) 180. Browser 106 may transmit direct metric query 140 to metric systems 154 in response to a metrics request by user 104. Metrics 162 and metrics 164 may be generated at least in part in response to direct metric query 140.

Browser 106 may transmit a freeform search (FS) 194 to computing system 102. FS 194 may include signals generated by user 104, and transmitted to computing system 102 via browser 106. Computing system 102 may process FS 194 signals, and transmit filtered and ranked events (F&RE) 192 back to user 104 via browser 106. A bidirectional chat 190 may be implemented between computing system 102 and user 104 via browser 106.

Multitenant training lake 182 may be configured to receive anonymized signals 184 from computing system 102. Anonymized signals 184 may be signals extracted from the different signals received by computing system 102, with all owner-identifying data removed from anonymized signals 184. Anonymized signals 184 may be processed by multitenant training lake 182 to generate optimized anomaly detectors 186. Optimized anomaly detectors 186 inform computing system 102 regarding any anomalous operation associated with a software that is being analyzed as a part of an ongoing SDLC process.

In an aspect, runbook synthesis 188 is configured to present the user with a runbook-a dynamic user interface/dashboard that presents a comprehensive, user-configurable view of the different signals processed by computing system 102.

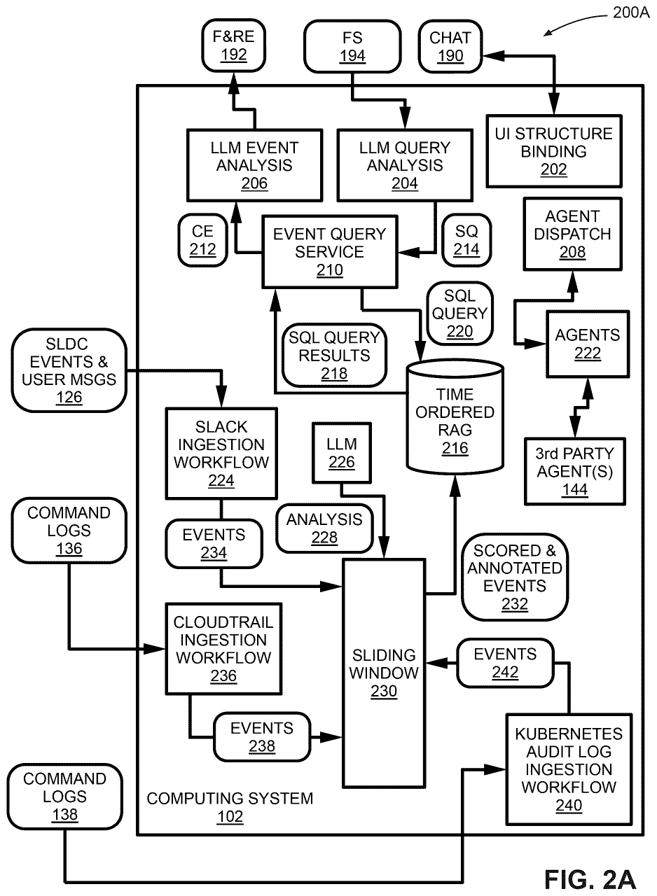

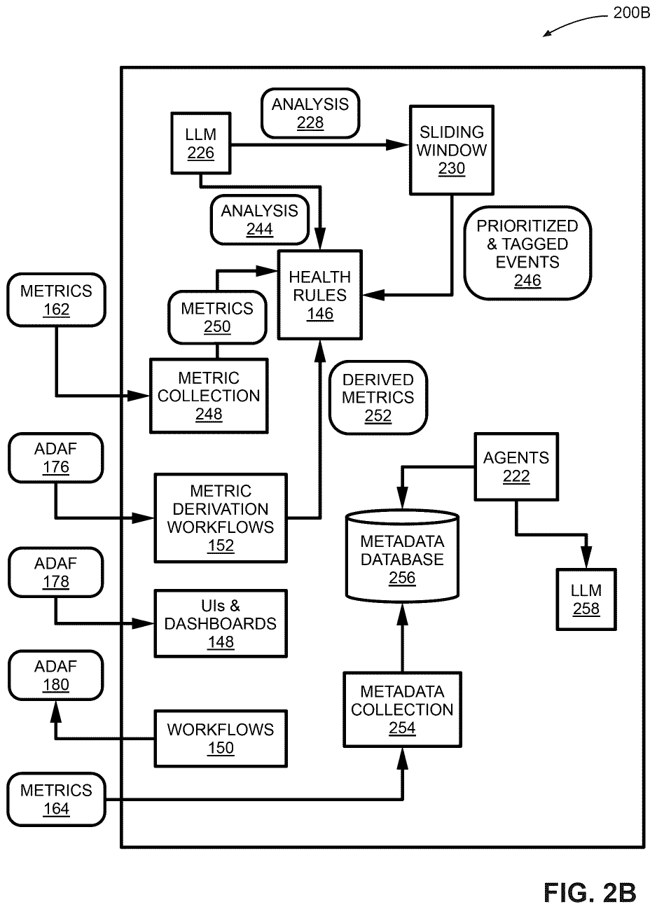

Collectively, interfaces 100A and 100B comprise a unified system architecture associated with computing system 102. A detailed functional description of an internal architecture of computing system 102 is presented in FIGS. 2A and 2B.

FIG. 2A is a block diagram depicting an architecture 200A of computing system 102. As depicted, architecture 200A includes LLM event analysis 206, LLM query analysis 204, UI structure binding 202, event query service 210, agent dispatch 208, agents 222, 3^{rd} party agents 144, time ordered RAG 216, Slack ingestion workflow 224, LLM 226, CloudTrail ingestion workflow 236, Kubernetes audit log ingestion workflow 240, and sliding window 230.

Bidirectional chat 190 is received by UI structure binding 202. UI structure binding 202 also transmits chat responses via bidirectional chat 190. LLM query analysis 204 receives FS 194, analyzes the search data of the freeform search, and transmits the search data as a structured query (SQ) 214 to event query service 210. Event query service 210 may use SQ 214 data to access time ordered RAG 216 via an SQL query 220. Event query service 210 may retrieve SQL query results 218 from time ordered RAG 216 in response to SQL query 220, and transmit the SQL query results 218 to LLM event analysis 206 as canonical events (CE) 212. LLM event analysis 206 processes CE 212, and outputs F&RE 192, which is transmitted to user 104 via browser 106. Essentially, the user presents a freeform search 194, and the associated components of computing system 102 (i.e., LLM query analysis 204, event query service 210, and LLM event analysis 206) perform the requisite operations to generate filtered and ranked events 192 in response to the freeform search 194.

In an aspect, SLDC events and user messages 126 is/are received by Slack ingestion workflow 224. Slack ingestion workflow 224 identifies one or more events 234 associated with SLDC events and user messages 126, and forwards these events 234 to sliding window 230 for analysis.

In an aspect, command logs 136 are received by CloudTrail ingestion workflow 236. CloudTrail ingestion workflow 236 identifies one or more events 238 associated with command logs 136 generated by AWS CloudTrail 132, and forwards these events 238 to sliding window 230 for analysis.

In an aspect, command logs 138 are received by Kubernetes audit log ingestion workflow 240. Kubernetes audit log ingestion workflow 240 identifies one or more events 242 associated with command logs 138 generated by Kubernetes audit log 134, and forwards these events 242 to sliding window 230 for analysis.

Sliding window 230 receives events 234, events 238, and events 242, along with analysis 228 from LLM 226, and processes all these inputs to generate scored & annotated events 232, that are stored in time ordered RAG 216.

In an aspect, agent dispatch 208 may be configured to manage one or more agents 222. Of these agents, some agents may be 3^{rd} party agents 144. Further details about the agentic framework associated with computing system 102 are provided subsequently.

FIG. 2B is a block diagram depicting an architecture 200B of computing system 102. As depicted, architecture 200B includes LLM 226, sliding window 230, health rules 146, metric collection 248, metric derivation workflows 152, UIs & dashboards 148, workflows 150, metadata collection 254, metadata database 256, agents 222, and LLM 258.

In an aspect, LLM 226 outputs analysis 228 to sliding window 230, which uses the analysis 228 while processing events 234, events 238, and events 242, to generate prioritized & tagged events 246, which are received by health rules 146. Health rules 146 may also receive analysis 244 from LLM 266.

In an aspect, metrics 162 are received by metric collection 248, and then forwarded in an appropriate format as metrics 250, to health rules 146. Metric derivation workflows 152 may be configured to receive any data in any format 176. Metric derivation workflows 152 may extract derived metrics 252 from ADAF 176, and transmit the derived metrics 252 to health rules 146. Health rules 146 may process analysis 244, prioritized & tagged events 246, metrics 250, and derived metrics 252 to generate alerts 124.

In an aspect, any data in any format 178 is received by UIs & dashboards 148, and used to generate one or more user interfaces and dashboards to be presented to user 104. Workflows 150 may generate any data in any format 180 to be transmitted to APIs 166.

Metrics 164 may be received by metadata collection 254, and stored in metadata database 256. Data from agents 222 may be stored in metadata database 256, while also used to train LLM 258.

Collectively, architectures 200A and 200B comprise an internal system architecture associated with computing system 102. The system architectures 100A, 100B, 200A and 200B show the SRE/DevOps user 104, accessing a browser-based application (i.e., an application communicating with computing system 102, and accessed by user 104 via browser 106) and Slack system 116 (an enterprise messaging system). In an aspect, each instantiation of the browser-based application is referred to as a “tenant”. In an aspect, browser 106 is included in computing system 102. In another aspect, browser 106 runs on a user computing system (not depicted), while computing system 102 and associated components are a remote computing system (e.g., a cloud computing system).

In general, a tenant is a unit of isolation. A customer (e.g., user 104) may have one or more tenants, and within each tenant all functional elements exist as described herein. However, the architecture presented herein does not imply that “hard tenancy” is used vs “soft” or “virtual tenancy”. For example, tenants can be virtual or soft isolated in the RAG 216 by providing database-schema level isolation. Or they can be isolated at the SQL level using row-level attributes. Or, hard isolation can be used to bring up a complete isolated infrastructure stack for each customer. The choice of hard or soft isolation depends on customer deployment requirements which may include “on prem”, which means deployed on customer premises, not in the cloud. In such cases hard isolation is used. Hence the architecture described herein is logical, not physical. In an aspect, 3rd party agents 144, health rules 146, UIs & dashboards 148, workflows 150, and metric derivation workflows represent “pluggable” capabilities that are deployed by applications; both customer (3rd party apps) and manufacturer-built apps (1st party apps) can be deployed.

### External Connections to Computing System 102

This section elaborates on SDLC events, audit logs/events, metrics, and API sources that computing system 102 ingests to obtain the “raw materials” for signal extraction and inference.

SDLC systems 108 generating SLDC events 118—A typical customer has at least 10 sources of SDLC events 118, and within each source there are multiple “lanes” of related events. For example, for an SDLC source such as a BitBucket sourcecode control server 112, individual sourcecode “repos” (repositories) on the server may constitute discrete streams or “lanes” of data. It is common practice for SDLC systems such as build servers, source code control systems, and bug/ticketing systems to be configured to emit events onto Slack. For example, a Jenkins server (e.g., Jenkins server 110) is easily configured to emit a Slack message to #devops Slack channel, for every build step it performs. SRE/DevOps engineers are able to see these messages on slack. This visibility and ubiquity has popularized slack as a form of SDLC message bus. Therefore, to minimize the number of systems that a tenant associated with computing system 102 must be authorized to access, computing system 102 typically relies on Slack or an equivalent messaging system as a nexus for SDLC event ingestion. In an aspect, computing system 102 provides the customer with a Slack Application, that the customer authorizes using simple and typical instructions for a Slack application. This grants the app associated with user 104 read-only access to both current Slack messages, and the complete Slack history. The customer controls which Slack channels this applies to by inviting @alertd (a user account associated with computing system 102, also referred to as “AlertD”) to the Slack channels of their choosing. In this way, Slack channels used by DevOps/SRE, which already exist in an organization, provide a low friction onboarding approach for SDLC events into AlertD. In an aspect, SDLC events 118 can be comprised of unstructured or semi-structured text, hence differentiated from log-based or metric based alerting systems that rely on structure/regexes.

Audit Systems 130—Audit logs provide exact details on commands that were executed against operational systems like Kubernetes and AWS (e.g., Kubernetes audit log 134 and AWS CloudTrail 132, respectively). The logs tell which user (both human and machine-service-account) executed which commands. These logs are actually exact records of API calls. The information in typical audit logs like CloudTrail 132 and Kubernetes Audit Logs 134 provides a crucial “source of truth” that can be correlated against less specific messages emitted from SDLC service accounts and humans. For example, an engineer engaged in rolling back a broken build artifact might generate a Slack message stating “I reverted the file on 53”. S/he leaves no other trace to their colleagues about how they actually did this. Likewise, an SDLC event generated by Jenkins 110 as a “build step” message might say “deployed ML model file”, but does not provide the detail of the 53 bucket the file was deployed to, or if the file overwrote a prior file. By using LLMs to correlating these non-specific “clues” with the actual audit logs, computing system 102 is able to attribute specific and reproducible commands to both causes of problems, and problem resolutions. This enables computing system 102 to synthesize actionable runbooks with real commands that engineers can use, vs nebulous instructions like “roll back a file in 53”. LLMs are well-suited to these kinds of correlative tasks.

Metric Systems 154—metric systems such as AWS CloudWatch provide traditional olly metrics. For a typical AlertD customer, the number of unique CloudWatch metric time-series ranges in the high hundreds to tens of thousands. This is because virtually every piece of infrastructure generates a unique time series identified by unique combinations of metric dimensions. As infrastructure becomes increasingly ephemeral and horizontally scaled, the number of these time series increases. For example, a HPA deployment in Kubernetes with continuous deployments across 10 microservices, might generate thousands of unique time series every day, all of which are retained for many days even after a given pod stops generating metrics. AlertD uses these metrics in two ways:
On demand from browser 106—the Correlate view in the AlertD UI (powered, for example, by StateD) fetches CloudWatch metrics directly from CloudWatch. In general, the volume and variety problem for metrics has exceeded the SRE/DevOps ability to keep track of what is relevant. In an aspect, AlertD implemented on computing system 102 uses AI/LLM implementation(s) to determine which metrics-dimension combinations are most relevant to provide insights into a current “situation”, based on analyzing metrics 162 and metrics 164. A nature of the current “situation” is ascertained by the LLM 226 by analysis of SDLC events. CloudWatch query, including Metric Math expressions, are used to extract highly relevant metric time series. For example, if the SDLC events indicate a problem with a particular service, AlertD is able to fetch metric time series for the pods in that cluster, and filter those time series to pods that are the least healthy. This ability to triage the correct metric signals from thousands of available signals is of extremely high value to SRE/DevOps.

Continuous backend ingestion—metric signals (e.g., 162 and 164) play a key role in determining the health of systems under observation. In an aspect, the issue of which signals to ingest is a difficult one for SRE/DevOps. Once again the large volume of available metric signals and the continuous variation in available dimensions (pods are initialized and de-initialized, for example) requires humans to make substantial investments in managing and applying tags/labels to infrastructure, and ensuring these tags/metrics manifest as dimensions of complexity. AlertD instantiated using the architecture of computing system 102 uses AI/LLM implementations to determine which signals are currently available and to balance the cost of ingestion and processing with the value of these signals. AlertD uses knowledge of the customer's architecture to determine which signals are of high value. Some embodiments include one or more agents 222 that work with the end user to interactively formulate a monitoring plan that optimizes selection of ingested metrics. Once ingested, these metrics are observed using multiple means of anomaly detection to drive proactive alerting of health problems.

APIs 166—Traditional approaches to ingesting observability metrics are generally labor intensive for the SRE/DevOps. In order to obviate these labor heavy approaches, an ability to flexibly interact with a diverse set of application programming interfaces (APIs) with workflows that can process data and chain APIs is beneficial. Not only is this functionality needed for internal purposes, such as supporting dynamic monitoring of available metrics-vs static creation of dozens of dashboards, some customers may also need this capability to build custom API connectors. A simple example of a continuous API ingestion workflow is that of metric triage. In order to determine which metric time-series are available (e.g., an inventory), AlertD must run an API processing workflow that uses the AWS List Metrics API to list all available time-series, and then initiate ingestion on relevant metrics. Such a workflow involves chaining a traditional API call output to an LLM with a specific prompt/instruction for filtering the results. As for 3rd parties, it is difficult to predict exactly what APIs will be selected to interact with or how. For example, a 3rd party developer may want to build an AlertD app for monitoring a MongoDB. This AlertD app may be instantiated on computing system 102, or on a user computing system, with a the app being configured to communicate with computing system 102. MongoDB metrics such as an associated heartbeat metric may be accessible only from proprietary APIs. For this reason it is crucial that AlertD expose a framework allowing 3rd parties to access arbitrary authenticated APIs, and to process, and react to data ingested from these APIs.

### Metadata Collection 254

Metadata plays a crucial role in providing AlertD agents with real-time about what infrastructure is deployed and accessible to the end user. In an aspect, metadata collection services 254 (running, for example, as StateD templates) are used to periodically collect metadata. For example, a crucial piece of metadata is that which is collected by the metadata collection template that runs AWS list-metrics, as a part of metrics 164. This command yields the metric namespaces and names, and their unique dimension combinations.

One exemplary table in the metadata database 256 is the dimensions table, which has the following structure:

INSERT OR REPLACE INTO Dimensions (
metric Id, MetricName, DimensionName, Dimension Value,
Names pace, timestamp
VALUES (?, ?, ? , ? , ?, CURRENT_TIMESTAMP);

The dimensions table 256 associates combinations of metric DimensionName and Dimension Value pairs with a metricID. Understanding the table, executing queries against it, and interpreting the results is something that would require substantial time building SQL queries and analyzing large result sets. AlertD's AWS Explorer Agent (e.g., included in agents 222) takes this burden entirely off the end user; in fact the end user is not even aware that a SQL database is used.

Metric Derivation Workflows 152—The system architecture diagrams 100A, 100B, 200A, and 200B illustrate that health rules 146 can be driven by conditions applied to metrics. However, traditional metrics do not capture many real situational indicators. For example, consider the situation of a self-driving car company and a problem caused by their build system. When the build deposits files into S3, as part of the software update package for a vehicle, it sometimes happens that files are deposited which exceed the 400 MB maximum allowable size of a single file that the vehicle's OTA loader can handle. When this happens it is catastrophic because the entire fleet must have every car's loader manually reset which causes loss of 24 hours drivetime for the entire fleet. For this reason it is critical that such “bad builds” get detected quickly. Unfortunately there is no CloudWatch metric that measures counts of files greater than a particular size.

As described herein, StateD templates are ideal for polling APIs and transforming data received from those APIs into metrics. For example, a StateD template, continuously polling AWS 53 list APIs can produce a metric that counts the number of files whose size is greater than 400 MB. Essentially, metric derivation is a subset of custom workflows. Any workflow that produces a metric by using APIs that are not in and of themselves metric APIs is by definition a metric derivation workflow.

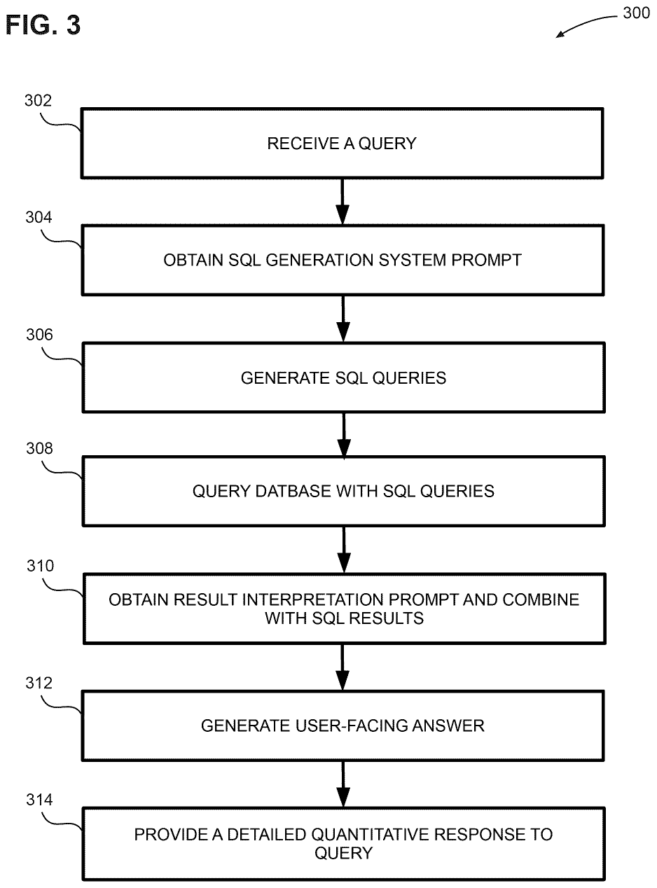

FIG. 3 is a flow diagram depicting a method 300 to process a query generated by, for example user 104 and received by computing system 102 via browser 106.

Method 300 includes receiving a query (302). In an aspect, this query is regarding one or more EBS volumes. For example, a query may be received by LLM query analysis 204 as a freeform search 194.

Method 300 includes obtaining an SQL generation system prompt (304). For example, LLM query analysis 204 may generate structured query 214 based on freeform search 194.

Method 300 includes generating SQL queries (306). Event query service 210 may receive structured query 214 and generate SQL query 220. In an aspect, event query service 210 generates multiple SQL queries based on multiple freeform searches.

Method 300 includes querying a database with the SQL queries (308). For example, event query service may query time ordered RAG 216 with SQL query 220.

Method 300 includes obtaining a result interpretation prompt and combining the result interpretation prompt with SQL results (310). For example, event query service 210 generates canonical events 212 in response to SQL query results retrieved from time ordered RAG 216.

Method 300 incudes generating a user-facing answer (312). For example, in response to canonical events 212, LLM event analysis 206 generates filtered and ranked events 192.

Method 300 includes providing a detailed quantitative response to the user query (314). For example filtered and ranked events 192 are provided to user 104 via browser 106 (e.g., via a graphical user interface or dashboard presented on browser 106).

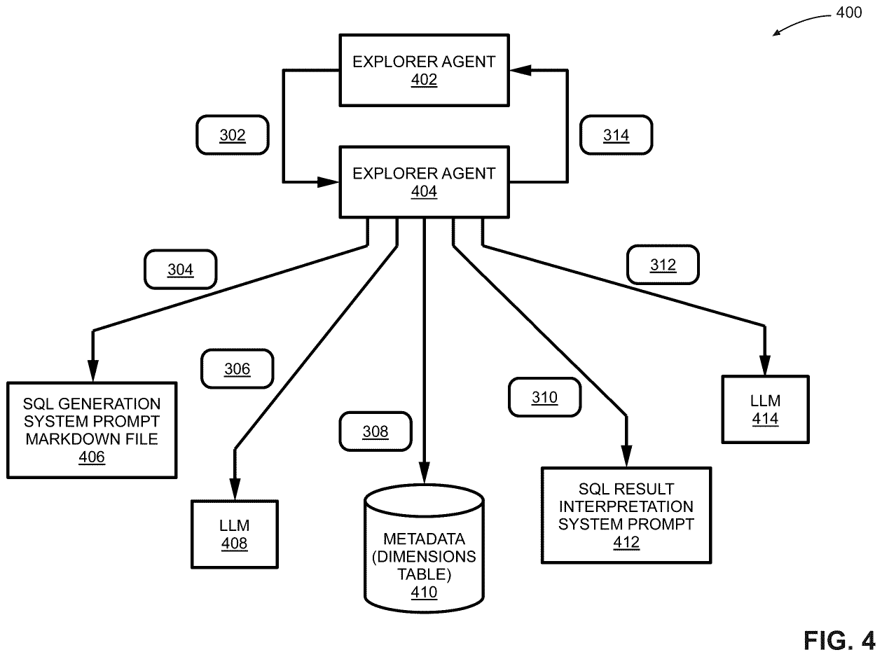

FIG. 4 is a block diagram of a computer system architecture 400 configured to process a query. In an aspect, computer system architecture 400 is included in computing system 102. As depicted, computer system architecture 400 includes explorer agent 402 and explorer agent 404. Each of explorer agent 402 and explorer agent 404 may be included in agents 222. Each of explorer agent 402 and explorer agent 404 may be an AlertD agent.

In an aspect, explorer agent 404 receives a query from explorer agent 402 (302). For example, user 104 may provide a query, “What EBS volumes do I have?” as a freeform search query 194. In response to the query, the explorer agent 404:
Generates SQL generation system prompt markdown file 406 as a part of 304.
Uses an LLM 408 to generate SQL queries (306).
Queries metadata database 410 that includes a dimensions table (308). Metadata database may be similar to metadata database 256.
Receives an SQL result interpretation system prompt 412 in response to the SQL query (310).
Uses an LLM 414 to generate a user-facing answer (312).
Provides a detailed quantitative response to explorer agent 414 (314), for output to user 104.

In an aspect, explorer agent 404 is an AlertD AWS Explorer Agent that uses LLM 408 to generate SQL queries against the metadata, execute them, and use a second LLM 414 call to interpret the retrieved data.

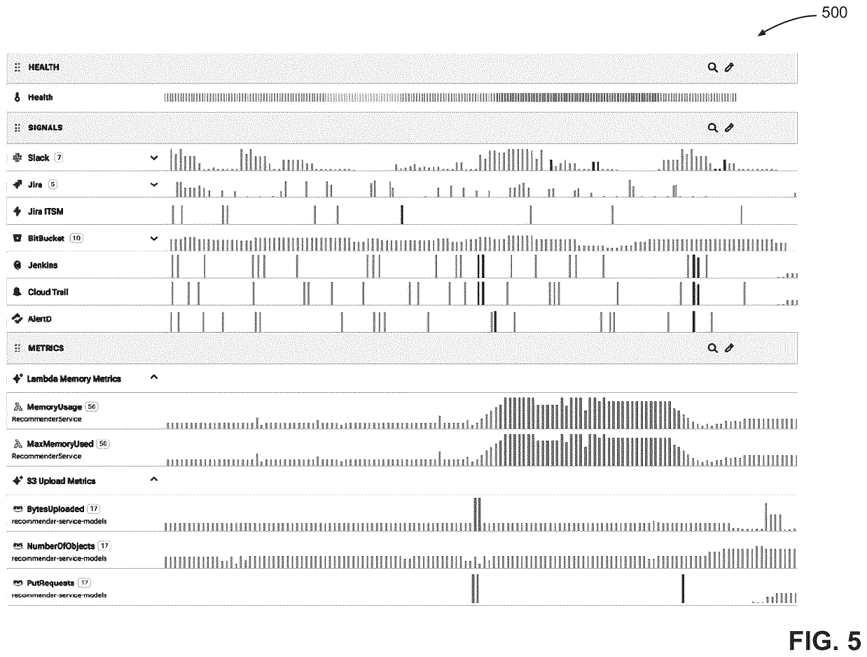

FIG. 5 is a screenshot of a user interface 500. User interface 500 may be displayed to user by, for example, browser 106, on a user computing system (not depicted). User interface 500 presents a combined health display, generated by health rules 146. Results presented in user interface 500, may be correlation results, as described subsequently.

Health rules 146 are an extensible part of the AlertD platform (computing system 102). FIG. 5 illustrates how combined (overall) health is typically displayed as a colored band. Colors are used to indicate different health conditions such as “unhealthy” and “healthy”, and/or distinguish between different signal categories. Using colors to represent different health conditions enable a user to identify different health conditions at a glance, rather than having to read through textual data to determine an existence of a health condition. Other aspects may use grayscale renditions to indicate different health conditions.

FIG. 5 illustrates that many health rules are present in the system, and that 3rd party applications can introduce domain-specific health rules. Traditional observability health rules are based on comparing numeric metric values to thresholds, such as a metric for “Memory Used (fraction)” to a threshold like:
Unhealthy: MemoryUsedFraction>0.85.
OK: 0.65<MemoryUsedFraction<=0.85
Good: 0.20<MemoryUsedFraction<=0.65
Unknown: 0<MemoryUsedFraction<=0.20

However, as can be seen in the FIG. 5, AlertD's health rules can be driven by metrics (native, or derived}, as well as by normalized events. As illustrated in FIG. 5, health rules can be provided by third parties and can access an LLM for the purpose of evaluating bespoke or even ad-hoc-customizable health rules. For example, many engineering organizations are organized around the “squads and teams” model. A member of the “IAM Team” might customize a health rule so that it continuously evaluates the following plain English health rules.
Health Rule: User Login Health
Unhealthy: “events with classification end_user_ticketing or customer_support and the messages pertain to issues like users being unable to login to the FoodSnap Mobile or web application“ ”
Good: “no events which describe problems with end users logging into foodsnap have been reported for 24 hours.”

### Multitenant Training Lake 182

In an aspect, AlertD (computing system 102) allows tenants the option to share anonymized data with AlertD for the purpose of improving performance for all customers. The multitenant training 182 lake is used to share metrics, and anonymized logs for the purpose of building anomaly detection models for numeric and semantic time series across multiple tenants' data. For example, the algorithms such as Chronos and TimesFM will benefit from training on data specific to the domain of anomaly detection in the SDLC. Models can also be customized and trained on data specific to a particular tenant. The “private training” option is available for customers with data too sensitive to share, or of too much proprietary advantage to share. Once built, anomaly detection algorithms are used with health rules to detect anomalous numeric metric patterns, and anomalous token/event sequences.

### Event Collection and Workflows

In FIG. 1A, three event collectors are shown:

Slack ingestion workflow—This workflow relates to SLDC systems 108 and

Slack system 116. This workflow receives Slack messages in real-time from customer approved channels. Slack messages include both human-generated, and SDLC-produced events where SDLC systems have been configured to emit messages to slack.

CloudTrail ingestion workflow—This workflow relates to command logs 136 generated by AWS CloudTrail 132. In an aspect, AWS CloudTrail 132 is configured to deliver to a CloudWatch logs group, which then delivers the logs via a Kinesis Firehose. The collector acts as a Kinesis Firehose HTTP Post endpoint for receiving the CloudTrail events in near real-time.

Kubernetes audit log ingestion workflow—This workflow relates to command logs 138 generated by Kubernetes audit log 134. In an aspect, Kubernetes is configured with FluentBit to deliver audit logs to an HTTP endpoint. The ingestion workflow acts as an HTTP receiver, in the same manner as the CloudTrail event receiver.

In an aspect, event collectors are implemented as StateD templates.

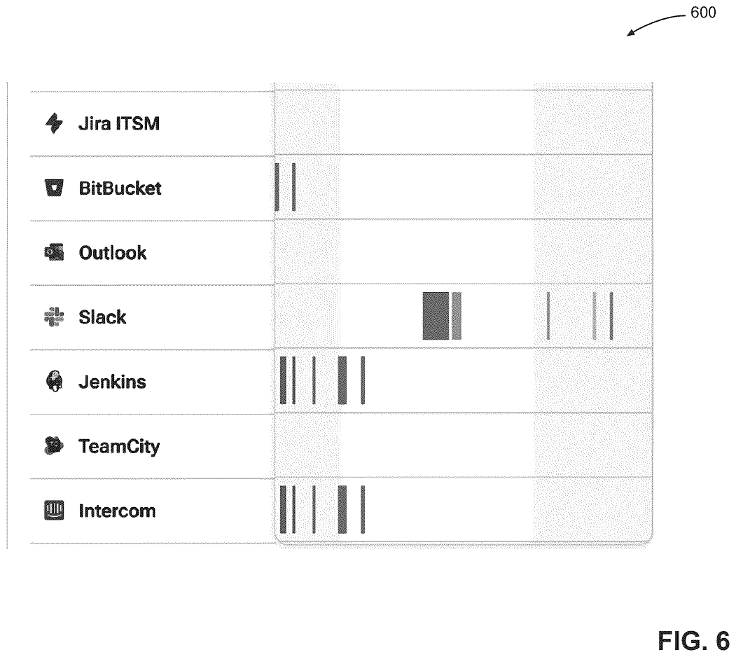

FIG. 6 is a screenshot of a user interface 600. User interface 600 presents user 104 with an event score, via browser 106. An event's score is a critical indicator of its relevance to the end user. AlertD (computing system 102) uses color/intensity as a means of calling attention to important events. FIG. 6 illustrates the use of color/intensity to highlight events, including discussions amongst humans, and their relative importance.

In an aspect, determining which events are “important” to a SRE/DevOps is a task well suited to an LLM. However, as large display time windows may cover thousands, tens of thousands, and even millions of events, the scoring of events is performed as events are ingested into the system. This “amortization” of the computation cost of large language models at “ingest time” allows the precomputed score to be used as a high performance retrieval and ranking index at query time.

FIG. 7 is a screenshot of a user interface 700 that provides a time display over very large time ranges, as described above.

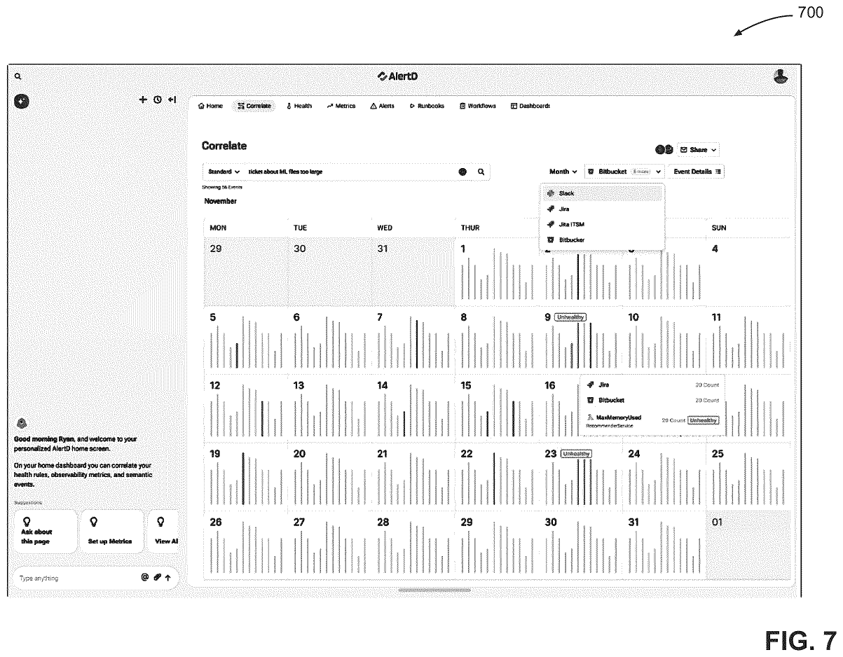

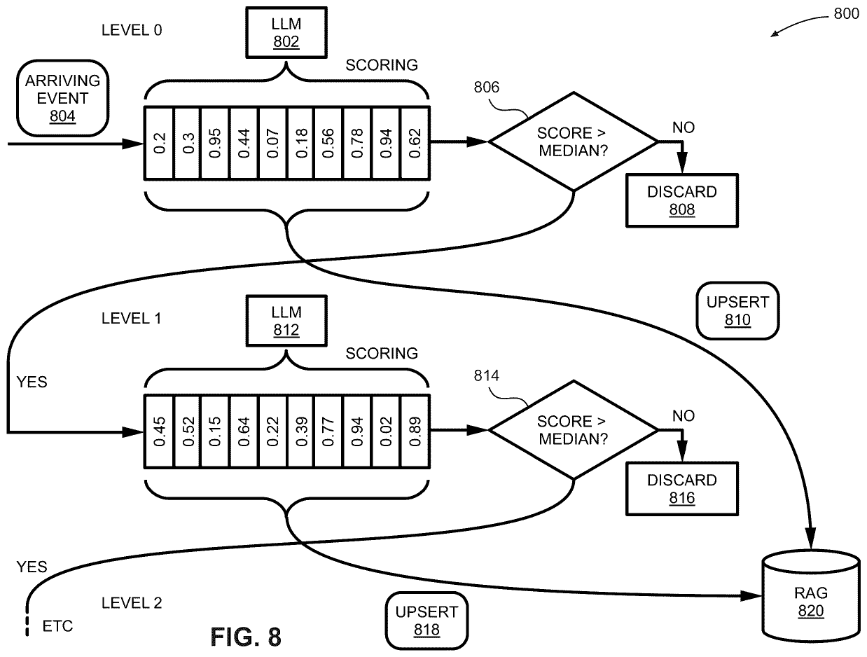

FIG. 8 is a data flow diagram depicting a sliding window data processing 800. The sliding window data processing 800 may be used to assign a score and rank to each event (e.g., arriving event 804). This sliding window data processing 800 may be implemented by sliding window 230. As SDLC events are ingested they pass through sliding window 230. In some embodiments, sliding window 230 is an n-event window. The arriving events are referred to as k₀ (level 0) or “real-time” events as they pass through the window. On each event arrival, an LLM 802 is used to score and rank every event in the window. Each event is assigned a score between 0 and 1, and ties are not allowed. The score is based on the relative importance of the events from an SRE/DevOps perspective. The score of these events can be used to color-code events in the UI (e.g., as presented in user interfaces 600 and 700). By default, setting a particular time range on the user interface retrieves events based on time alone and displays them based on their precomputed score.

Event scores are used to prioritize events for display at varying time-scales. Events are sorted by descending score, and the top-N events are chosen by display, with N being chosen based on the available display space. Displays of longer time ranges in the same screen space cover more events, therefore the Top-N events, by score, result in longer time ranges retrieving N-sized event windows that truncate lower scoring, less important events.

It should be noted that a user of the application can make a request like “show me messages related to build 1.2.8” and this can result dynamic re-ranking of results queried from the RAG 216.

In an aspect the score is informed by not just the level-0 event window, but by higher level “memory” windows which retain high ranking events over longer durations.

When an event exits then-event window, events with a score above the median for the window (i.e. the more “highly ranked events”) are promoted to the next level. For example, at 806, computing system 102 checks to determine if an event score is greater than a median value. If not, then the event is discarded (808). Otherwise, the event is promoted to the next level (in this case, level 1, or k₁). Every event in the windows is stored in the PGVector Retrieval Augmented Generation (RAG or “vector” 820) database for durability, and after each arriving event, and reranking, the event windows are upserted (e.g., 810 for level 0) for fault tolerance.

At level 1, the process repeats, where LLM 812 (which may be the same as LLM 802) is used to score and rank every event in the corresponding time window. At 814, each event score is checked to determine if an event score is greater than a median value. If not, then the event is discarded (816). Otherwise, the event is promoted to the next level, and so on. Every event in the windows is stored in the PGVector Retrieval Augmented Generation (RAG or “vector” 820) database for durability, and after each arriving event, and reranking, the event windows are upserted (e.g., 818 for level 1) for fault tolerance.

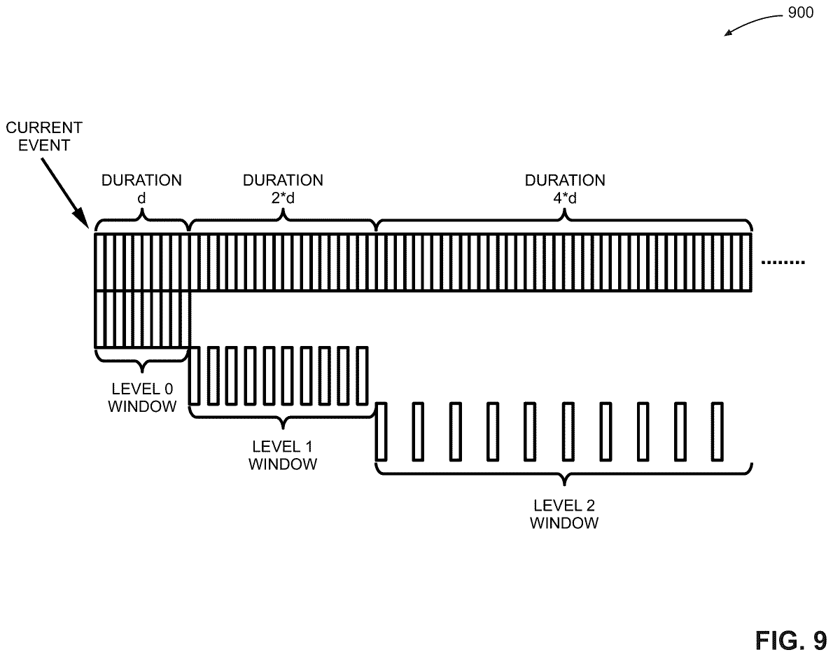

FIG. 9 is a data flow diagram depicting a sliding window data processing 900. Sliding window data processing may be implemented by sliding window 230. Sliding window data processing 900 is used to depict a relationship between event density time as generated by sliding window data processing 800. By definition of median, half the events will score higher than the median. This means that that the k₁ window corresponding to level 1, being the same size (n-events) as the k₀ window corresponding to level 0, will initially fill in after a duration twice that required to fill the k₀ window. So if the kₒ window covers a duration d of 5 minutes, the k₁ window covers a duration d₁ of 10 minutes on average but with half the event density. Also by definition of median, the events promoted to k₁ are the higher scoring half of the events in the ko window. By similar reasoning, the k₂ window spans 4*d 0, with the score of events at k₂ being the highest quartile of k₀. This process repeats K−1 times to produce K priority levels. At priority k, the duration of the window is 2^{k}*d₀ where d₀ is the duration at level 0, and the fraction of events is the highest scoring 2^{-k} of k₀.

FIG. 9 depicts these k windows where the event density and duration of the windows are used to further explain how these windows relate to each other. In FIG. 9, k=2 and the figure shows how the content of windows relates to each other temporally. The windows provide dense coverage through durations proximate to the current event, with event coverage becoming sparser the farther back the event history is examined temporally.

In an aspect, priority levels 1 to k serve as progressively lower fidelity event-memories, each serving a larger lookback duration, and retaining increasingly important events (, like a map tile in which only the most important features are retained as a user zooms out). These “memories” are crucial for linking causality or other relationships of prior events to currently arriving events.

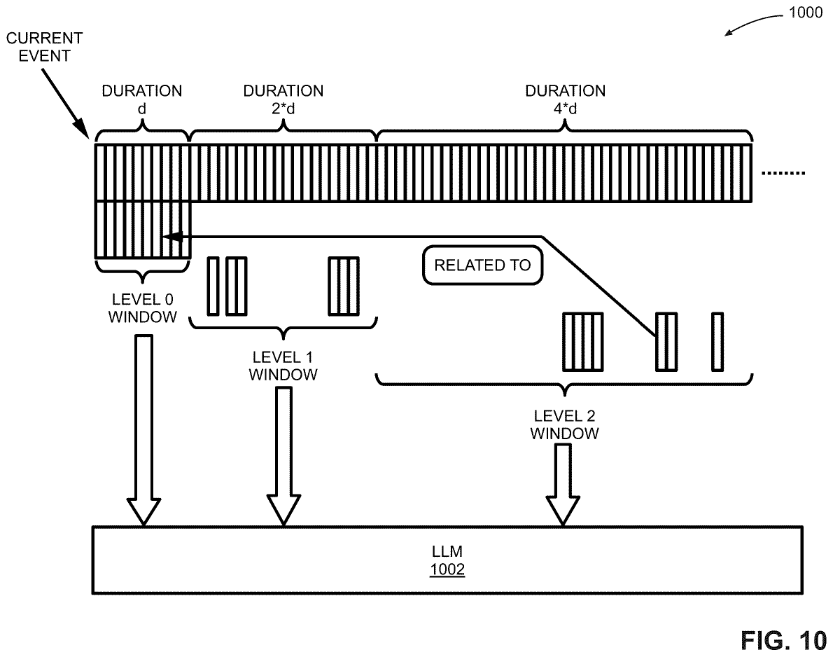

FIG. 10 is a data flow diagram depicting a sliding window data processing 1000. FIG. 10 depicts a more realistic implementation of sliding window data processing 900. While FIG. 9 appears to show the sampling appearing at precise regular intervals, this is not the case in reality. In reality there will be variance in the number and spacing of events within windows at k≥1. FIG. 10 below shows a more accurate depiction of content selection in the windows where k≥1. FIG. 10 shows the ultimate purpose for retaining very important events, from the past, for co-consideration by the LLM along with current events. It allows relationships, including causal relationships, to be detected between current and past events while reducing the number of events that must be fed to the LLM from m to log(m) for any event history window of size m. In any algorithm, when the processing can be reduced from O(m) to O(log(m)) this is considered to be one of the most powerful “big o” reductions that can be achieved by an algorithm. This implementation enables computing system 102 to draw useful relationships across large lookback windows using fractions of the compute required for a linearly scaling algorithm. This can be visualized in the diagram below where the algorithm feeds only the events in the level 0, level 1, and level 2 windows to the LLM, while a linearly scaling algorithm feeds all the events to the LLM.

### Related Events and Causal Linkage

Upon each new event arrival and re-ranking of the window contents, the LLM examines all of the k*n events across all windows and edits the relatedEvents array attached to each event in the Po window. The maximum number of relatedEvents is configurable, “r”. The r highest-scoring related events are added to the list, and human readable relationship field is added explaining the relationship. This forms a logical graph with weighted edges between related events.

### Standard Event Fields

This section describes the purpose of each field in the “normalized” event structure that is stored in the vector database. It is important to have a normalized event structure so that events having different fields and structures in their native format can be mapped to a canonical structure supporting useful queries regardless of their original structure.
score—the relative importance score of the event (explained earlier) id-globally unique event Id
eventTime—a timestamp that was extracted from the event itself
ingestTime—timestamp applied by the vector store on insertion
raw—the exact content of the original event with no interpretation or change
object: the parsed and structured version of the raw event (the object field can be structure-searched)
source—an identifier, indicating where the event came from (its source)
classification—SetbytheLLM ingestion stage described earlier, classifying the event as one of
   source_control
   ticketing
   conversation
   build
   deploy
   other (note that this list of available classifications is configurable)
moniker—a shorthand for the source
users—a list of users related to the event
summary—an LLM generated summarization of the event
relatedEvents (described earlier)
annotations: The top level keys

### Event Indexing

To support searching, events are inserted into time ordered RAG 216, a database that supports both “vector” indexing, and traditional 1-dimensional database indexing. In an aspect, the standard event fields are indexed in the rag to support temporal vector searching, as well as temporal exact match searching, as well as combinations of exact and vector match across varying fields.

### Searching

A user interface provided to user 104 by computing system 102 supports the ability to search for events. For example, a user might enter “ticket about ML files too large”. Searching is performed by using the vector index over the canonicalized events stored in the Time Series RAG.

### Chop Time

In order to optimize the display of both search results and their relevant and temporally proximate SDLC events and metrics, computing system 102 may implement a display concept called “chop time”, where the left-to-right timeline is split into discontinuous regions. Such a region is referred to as “chop time” because it chops out the irrelevant portions of the time line that do not contain query hits.

### Query Preprocessing

In an aspect, LLM query analysis 204 transforms a freeform query (i.e., freeform search 194) into a more structured query 214. The structured query 214 is executed by the event query service 210 by translating the structured query into SQL 220.

### Query Preprocessing Example 1

When the user types “tickets about ML files too large” as a freeform search, an LLM can be used to infer the structured equivalent of their query. The LLM can be used to identify and constrain fields that should exist in any events returned from the search. This is known as the “query by example” pattern. In the section called Standard Event Fields, several standard fields of events stored in the RAG have been described. One such field is classification. Therefore, the query in the example above means “we are searching for events that have classification equal to “ticketing”, and within those constrained events, we are performing vector search against the raw message content.”

### Query Preprocessing Example 2

The user searches: “tickets with title like ML Files too large”. This example demonstrates the recognition of “deep structure” such as ‘title’ which implies searching over the parsed object.

### Query Preprocessing Example 3

The user searches: “tickets with title or content like ML Files too large”. The LLM analysis recognizes that this is a Boolean OR expression whose left-hand-side (LHS) covers the object title and right-hand-side (RHS) covers the object body. Note that the analysis also recognized the meaning of “content” to imply the body field of the object. To do this, the LLM analysis prompt includes the schema for each classification.

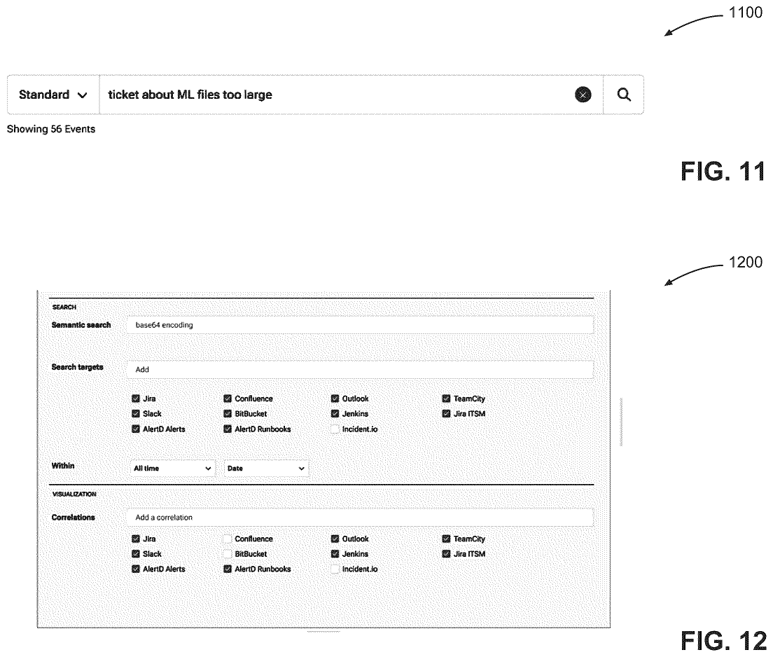

FIG. 11 is a screenshot of a user interface 1100. As depicted, user interface 1200 is a search interface for the Correlate UI. In “Standard” mode (shown on the dropdown in FIG. 11). In an aspect, the conversions from freeform to structured query happen internally and are not revealed to the user. However, selecting “Structured” instead of “Standard” allows the user to manually separate the specification of the search “targets” from the semantic portion of the search. For example, the structured search below will search the selected targets for “base64 encoding”.

FIG. 12 is a screenshot of a user interface 1200. FIG. 122 shows a structured search version of the user interface 1100. Using the structured input field above results in a structured search object.

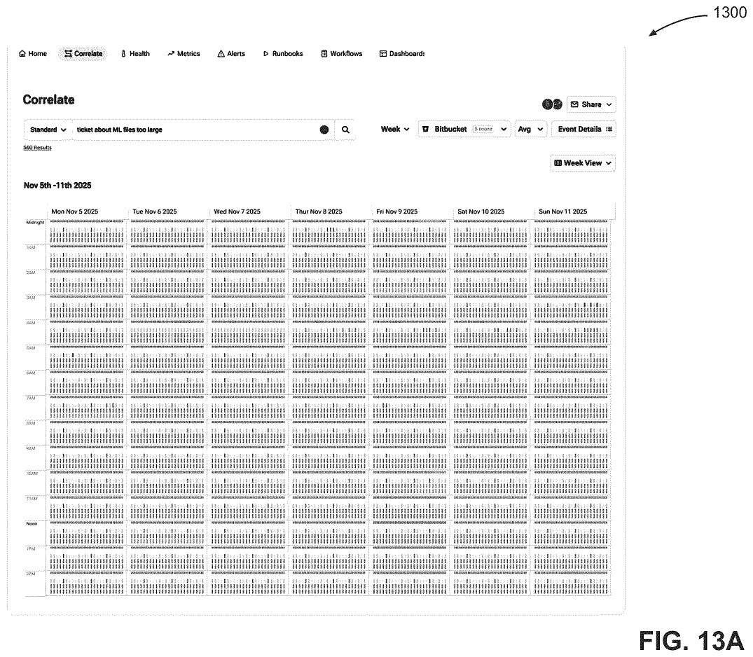

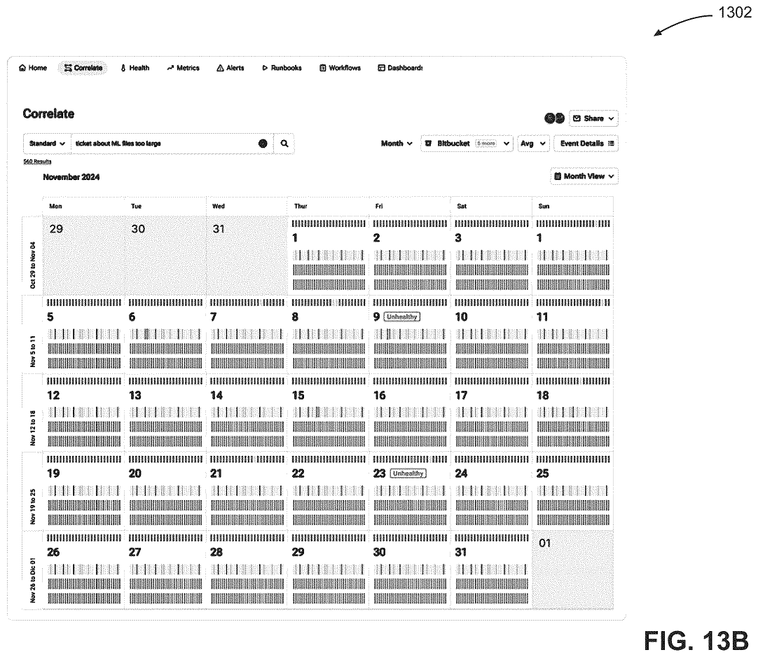

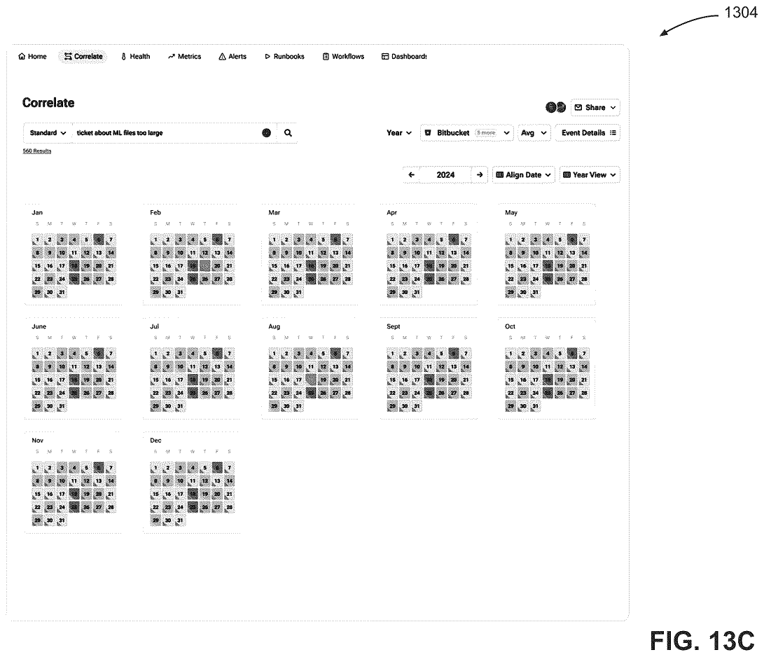

FIGS. 13A, 13B and 13C are screenshots 1300, 1302 and 1304, respectively of different user interfaces that depict results from computing system 102 in a respective calendar view.

### Query Execution

The Event Query service is responsible for translating JSON structured queries into SQL queries on the target database.

### Query Post Processing

Consider now, canonical events 212 input to labeled LLM event analysis 206. This is a query results post-processing phase. Canonical events 121 from the database 216 are analyzed by an LLM (206) before delivery to the application in the browser. The quality of vector querying can be highly dependent on chunking and other factors that are not straightforward to optimize, which means the SQL query can deliver false positives. Therefore, post processing the results using an LLM (206) provides a mechanism to rank the results that is more effective than the ranking provided by the vector retrieval function. Post processing can also be used to enforce certain structural query constraints that are difficult to enforce without creating vector indexes on multiple fields (which would degrade performance on both space and time).

### AI-Powered Dashboarding

In the field of observability, dashboards are used to assemble collections of metrics related to a particular use case. Prebuilt dashboards are labor intensive and deliver suboptimal results. Several challenges arise in using today's “prebuilt dashboards”.

Ephemerality—Consider the fact that pods (e.g., Kubernetes pods) are ephemeral. It is therefore not practical to build a dashboard that hard-codes the pod id as a way to power the metric query. Therefore, dashboards must be parameterized on multiple levels which involves a form of programing specific to the “dashboarding language” such as Grafana or SimpleXML for Splunk. For example, a first parameter, manifested as a dropdown might collect the namespace from the user. The list of namespaces powering the dropdown might be hard coded from a list of well-known namespaces within the organization. Once a namespace is selected, a list of pod IDs can be obtained by querying the Kubernetes cluster, and providing namespace as the parameter. The need to make dashboards parameterized and interactive, allowing them to work on both “namespace A” and “namespace B” illustrates the up-front work and complexity of dashboard building.

Opacity—The “I don't know what I don't know” problem is pervasive at multiple levels. Due to the skill required to build useful dashboards, the “audience” for a dashboard is wider than the community of “authors”, and the skill of authors is prized. Most members of the “audience” for a dashboard do not know what signals are available, might be informative to the current situation, or how to build dashboards for those signals. This limits many audience members to observing the system through whatever pre-built dashboards have been created by authors.

Deployment complexity—Because dashboards are hard to build, but essential for observability, many organizations invest in teams (often the SRE team) that build dashboard templates geared toward certain service “shapes”. These templates are expected to be adopted by service teams as part of their CI/CD workflow. The deployment artifacts for a service are expected to include dashboards built from the templates provided by the SRE team. Maintenance of dashboard in the deployment pipeline (“configuration as code”) creates yet another step for service owners, albeit the lessor of the known evils. One of the perils of dashboard templates is the risk that a dashboard template can be deployed with bugs. Just like code, dashboard templates introduce complex expressions that must be understood by the team. It is possible that an entire environment can be accidentally decommissioned, and its infrastructure including databases, deleted by a terraform delete operation, all because a dashboard template was deployed without being properly configured. This can result in the dashboard showing metrics from the wrong environment, which can further lead to a conclusion that the environment was unused and could be decommissioned. In reality the environment may be a highly used demo environment which may be deleted days before a keynote demo. The team then may need to scramble to rebuild the environment and lost data, losing time and credibility.

information overload—When asked “what metrics are you currently collecting from your AWS deployment”, most engineers are able to name at best a few. And yet their AWS and Kubernetes deployments are generating thousands of unique metric timeseries across hundreds of unique CloudWatch metric names. This problem is exacerbated by the siloed nature of teams working on hybrid Kubernetes-based cloud microservices. Understanding the metrics that are generated by services that are not owned by a team, but that affect the team is exacerbated by the huge number of interactions between microservices and cloud infrastructure. In one survey, exactly zero engineers surveyed had any process for regularly reviewing the results of commands like AWS list-metrics which means they had no handle at all on what signals are even available to them.

Documentation chaos—Generally speaking, there is no single source of truth in AWS documentation for a list of all metrics available across all services. Some implementations may need to draw from hundreds of disparate AWS documentation pages and create a custom database of services, metrics, dimensions, that powers an associated AWS agent. An example database spans 3,350 discrete CloudWatch metrics. There is no question that this exceeds the human capacity to even understand what metrics are available across a PaaS provider.

Time to deliver—Dashboards take time to build. Most dashboards are not created by forethought. They are created as a response to an outage or problem, with a manager asking the question “how do we make sure this never happens again” and the engineering team responding “we will setup a dashboard to give us better visibility”. When an outage is in progress, engineers often realize the types of dashboards that would help them debug the current problem, and they wish they had them, but the urgency to resolve the current problem, and to document it post mortem, rarely leaves time to create the relevant dashboards, with engineers asking “since the problem is resolved, should I work on features for the next release, or create dashboards that might not be needed again?”

Staleness and resource hogging—In a typical implementation in the prior art, a large financial institution had more than 11,000 dashboards spanning hundreds of global teams. One of the primary challenges was determining which dashboards were useful and which were stale. This was highly problematic because dashboards often include scheduled queries and reports that “prepare” the dashboard with up-to-date data, even if a user is not actively viewing the dashboard. This caused massive resource and scheduling contention. Everyone sensed that some large fraction of these dashboards could be deleted, but nobody was willing to risk removing a dashboard that “might be needed” in a war-room situation.

These are just a few of the ways in which today's dashboard frameworks fail to meet the needs of engineering teams. One of the key ways that the systems and methods described herein eliminate the problems above is by using Al to dynamically fetch the correct signals, based on an always up-to-date understanding of the SDLC. The systems and methods described herein in many ways present a “post dashboarding” mindset, in which relevant information is so easy to assemble and correlate that “prebuilt” dashboards can in many cases be replaced with views that are automatically curated by the Al, and can be modified through natural language by the end user.

Some implementations on computing system 102 present user 104 with bespoke view of metrics and SDLC events is curated by agents 222, requiring no initial input from the user 104. The agent(s) 222 explain(s) the current status, and explain(s) why it/they has/have chosen several, of thousands of available metrics, to provide evidence to support its/their assertions about the current “situation”. These bespoke views of metrics may be referred to as “correlate views”.

In an aspect, an initial selection of metrics and events in a correlate view, is curated automatically by the Al. Users of the product, rather than being asked to build a dashboard, or explain in detail what they want to see, are instead presented with an Al curated view, and a clear explanation of why the selected signals and metrics illuminate the situation at hand. This is extremely useful to the end user, since as mentioned before, information overload, documentation chaos, time to deliver, and many other roadblocks make the act of hand building this dashboard a multi-hour process, at best. The curated dashboard generated by computing system 102 and rendered, for example, on browser 106 for review by user 104 saves end-users hours of time, every time it is used.

In an aspect, the agentic framework deployed by computing system 102 (e.g., agents 222 and/or 3^{rd} party agents 144) is able to query the current SDLC events and user messages 126 using the event query service 210 as explained earlier, and to combine this with the results of AWS (162 and/or 164) list-metrics to understand the nature of the situation, what metrics might be helpful, and what metrics are actually available.

In an aspect, a combination of agents 222 and 3^{rd} party agents produces the following actual output for presentation in the chat, as well as a structured JSON output consumed by the UI:
Hey Ryan! I noticed some issues in your RecommenderService pipeline, so I pulled up the most relevant health rules and CloudWatch metrics for you. Here's why these specific metrics are displayed: Lambda Memory Metrics (MaxMemoryUsed, MemoryUsage) Why?: I detected errors and memory pressure immediately after a new version of the RecommenderService Lambda function was deployed.
Insight: Memory usage is often a limiting factor for Lambda when handling large files or payloads.
S3 Upload Metrics (BytesUploaded, NumberOfObjects, PutRequests)
Why?: The errors coincided with unusually large ML model files being uploaded to the recommender-service-models 53 bucket.
Insight: These uploads triggered size-related memory issues in the Lambda function. Lambda Invocation Metrics (Errors, Throttles, Invocations)
Why?: Invocation failures started immediately after the Lambda function was updated, suggesting a correlation with the deployment.
Insight: These metrics help confirm the impact of code or configuration changes on function health.
CloudTrail Events (UpdateFunctionCode, PutObject)
Why?: CloudTrail logs show that Jenkins-user updated the Lambda function and uploaded new files to S3.
Insight: Correlating these API calls with metrics helps pinpoint the timeline of root cause events.
I surfaced these metrics because they are highly correlated to the errors and performance degradation we're seeing. Let me walk you through what's going on:
Large ML files were uploaded to S3.
The Lambda function struggled to load these files due to memory limits.
Errors began shortly after the deployment by Jenkins Build #42.
Does this align with what you're investigating? Let me know if you′d like to dive into any specific metrics or events.

The analysis is performed automatically, in real-time, is comprehensive and accurate, and the visual output clearly allows the user to see and understand the nature of the current issue. This is an extremely valuable innovation for SRE/DevOps.

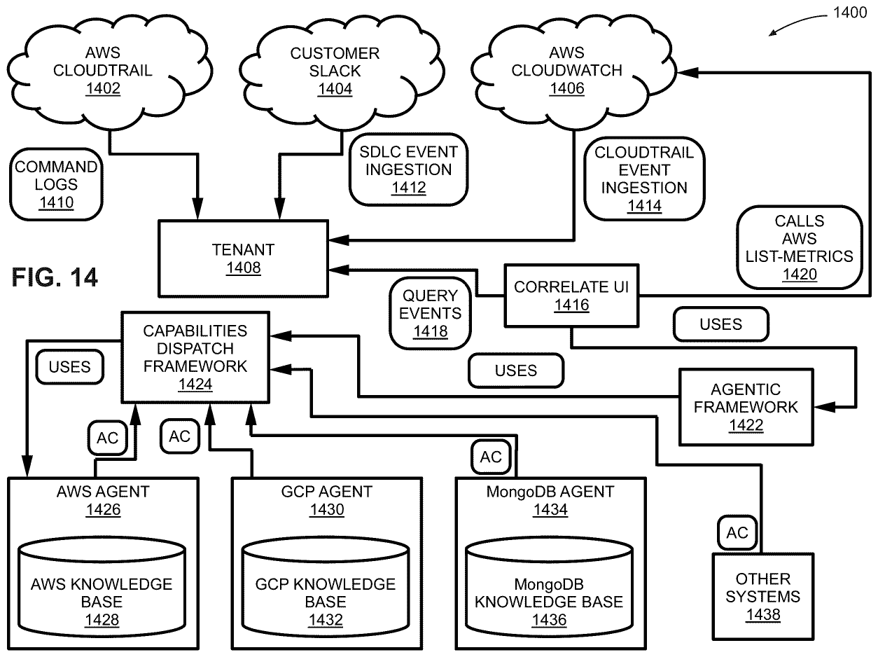

FIG. 14 is a block diagram depicting a computer architecture 1400 configured to process a plurality of inputs. Computer architecture 1400 depicts a tenant 1408, receiving various inputs from different sources. Specifically, tenant 1408 receives command logs 1410 from AWS CloudTrail 1402, SDLC event ingestion 1412 from customer Slack 1404, and CloudTrail event ingestion 1414 from AWS CloudWatch 1406. Tenant 1408 may be implemented on computing system 102, as an AlertD tenant.

A correlate UI 1416 may be a correlate UI as described above. Correlate UI 1416 may use an agentic framework 1422 associated with tenant 1408 (e.g., any combination of agents 222 and 3^{rd} party agents 144). The agentic framework 1422, in turn, may use capabilities dispatch framework 1424. Capabilities dispatch framework 1424 may use AWS agent 1426, such that AWS agent 1426 advertises capabilities (AC) to capabilities dispatch framework 1424 using data from an AWS knowledge base 1428. A GCP agent 1430 may use data from a GCP knowledge base 1432 to advertise capabilities (AC) to capabilities dispatch framework 1424. A MongoDB agent 1434 may use data from a MongoDB knowledge base 1436 to advertise capabilities (AC) to capabilities dispatch framework 1424. In an aspect, AWS agent 1426 and GCP agent 1430 are examples of agents 222, while MongoDB agent 1434 is an example of a 3^{rd} party agent 144. Computer architecture 1400 may include other systems 1438 that advertise capabilities (AC) to capabilities dispatch framework 1424. Correlate UI 1416 may output query events 1418 to tenant 1408.

In an aspect, correlate UI 1416 may include three main panels presented to user 104, as a “correlate view”, as presented in FIG. 22.

FIG. 14 illustrates the inputs and outputs to the agentic framework for the correlate screen. FIG. 14 explains how the Correlate UI logic is able to use these steps to produce the output shown above in both text, and UI form. The computer architecture 1400 performs the following:
Get the current lists of available CloudWatch metrics
Get a temporally ordered set of SDLC events that are both current and important select an agent or agents that is well suited to the task of metric selection
Use the selected agents to:
   Formulate the human readable chat messages that explain the metric selection
   Obtain a structured list of AWS metrics
Retrieve and display the metrics specified by the selected agent.

### Agentic Framework

AlertD's chat capabilities are built around an agentic framework. In an aspect, purpose-specific Al agent can be built around prompt engineering and content databases that power prompts. Some differences between an AlertD agentic framework and a single-purpose agent are as follows:
The selection of available agents is dynamic,
3rd parties are able to package and provide agents serving domains that AlertD has no expertise in, such as MongoDB monitoring, and
Agents advertise their capabilities, and the framework dynamically selects one or more agents to engage in conversation with the end user.

### Establishing User Intent

In order to triage the chat message's intent and dispatch it to the correct handler in the product, AlertD uses an agentic framework. For every chat message the framework must:
Determine the “intention” of the user chat input
Determine if some portion of the product, or 3rd party plugin/app, other than the current screen, might better serve the intention
Dispatch the user's chat message to the identified portion of the product, or demure (e.g. “I am sorry, I have been instructed to refer you to a Google search for questions about cat training.”}

To begin understanding this, consider this example where the user started at the Home Screen, and asked the AlertD Chat Agent to “find alerts for when ML files were too large”. As shown below, the agent responds “Sure. You have a Staged ML Files Too Large health rule that includes a derived metric to track the size of ML Files in S3. You can view your alert dashboard there.” The user responds with “I want to go there” at which point the agent responds by pulling up the Health Rules listing page with the correct health rule listed. This simple dialog illustrates that “behind the scenes” the chat agent is actually investigating different ways to answer the question, and reveal its findings (and potentially its chain-of-thought), THEN invite the user to jump to that portion of the product.

### Capabilities Metadata

To understand how pieces of the product “advertise” their capabilities to the agentic dispatching framework, it is essential to understand capabilities metadata. Individual screens in the AlertD application—as well as dashboards and visualizations provided by 3rd party applications on the AlertD Exchange—are each bundled with hierarchical metadata. “Hierarchical” meaning that each metadata is allowed an array of pointers to child metadata objects.

The metadata facilitates the process of dynamically interpreting the user's chat message, and determining which piece of the product, each containing dynamic prompt preambles, should be used to service the user's request. Metadata is written using the StateD language.

To keep an initial example simple, consider a metadata object that has no children in its hierarchy. For example, the code below shows the metadata for the Health Rules Listing page shown above. The Health Rules Listing page is example of a page whose metadata does not contain children because the screen's functionality is simple enough that a single prompt can be used to generate the content. This means that the prompt contained in the metadata below can be used to produce a structured response in “one shot” by expanding the user's chat message (the $MESSAGE variable) and the schema. The expanded prompt is then fed to the LLM along with chat history.
name: Health Rules Listing
breadcrumbs: [“Home”, “Health Rules Listing”]
capabilities:
   The Health Rules Listing Page provides a paginated list of all health rules. It includes the ability to search and filter for health rules by name, owner, creation date, modification date, and current status
prompt: |
   The user's message is $ {$MESSAGE}. You will answer the user's message using JSON that adheres to $ {schema}
schema: ${$fetch (′https://alertd. ai/@alertd/health/health_rules_list.schema j son′)}
children: [ ]

### The Prompt Dispatch Process

Given a user chat message like “find alerts for when ML files were too large”, a method/process called “prompt dispatch” is used first identify which metadata to use, and then to dispatch the user's chat message to the prompt defined in the identified metadata. The process is:
1. reduce over each metadata object in the system registry to create capabilities_array
2. pass the LLM the user query, and the capabilities_array, and ask it to return a relevance score between 0 and 1 for each capability relative to the user's chat message, and to also return a relevance explanation for the highest relevance capability
3. present the relevance explanation as user-visible ‘chain of thought’ in the chat interface.
4. invoke the chosen prompt

### Hierarchical Chains of Reasoning

Consider a user message “I wanna monitor a lambda function talking to an aurora database with read replication”. The desire is to build a comprehensive monitoring plan utilizing the correct AWS CloudWatch metrics. Our experimentation taught us that we cannot directly ask this question to an LLM, as the LLM is prone to hallucinating metric names that do not actually exist.

A naive approach to solving metric name hallucination would be to load a single prompt with thousands of metric names, descriptions, information about their defaults, user documentation, etc. However, this leads to a prompt so massive, that it becomes non-performant on many fronts: it does not fit in the context window; the LLM tends to “get lost” in the mass of text and ignore details, even when specifically provided; The cost to serve the query expands due to the high token count; the query latency increases; the quality of the result degrades.

To solve this problem AlertD Capabilities Metadata has a field called children that allows the creation of hierarchies of metadata that can progressively drill into the layers of data that can be used to respond to the user's message. Let's explore how the Health Rule Overview screen's metadata contains hierarchical Capabilities Metadata children that are used to “lead” the chat agent through a chain of reasoning. This sequence of precise steps, as opposed to the naive approach produces hallucination free results and allows large content databases to be split across prompts.

Again, given “I wanna monitor a lambda function talking to an aurora database with read replication” consider a chain of reasoning that might be echoed to the user as the LLM descend the capabilities hierarchy:

“it looks like you want to monitor AWS CloudWatch metrics in the aws/lambda namespace and the aws/rds namespace”

“For AWS/lambda you should monitor <explicit list of metrics>”

“For AWS/RDS you should monitor <explicit list of metrics>”

These chains of thought/reasoning help users observe and understand what the agent is doing. Much like how a real human agent might converse with a customer as they investigate an issue. Finally, the chat agent presents its answer in a combination of text chat and visual health rule tiles.

Next, consider how AlertD Capability Metadata can be built in a hierarchical forest to implement this kind of reasoning.

### Brute Force Hierarchical Reasoning

Returning to the example of CloudWatch metrics, some embodiments include a custom database of CloudWatch metrics, documenting some 3350 CloudWatch metrics across 182 CloudWatch namespaces. The following chain of thought/reasoning may be followed:
namespace selection: determine which of 182 AWS CloudWatch namespaces should be used
metric selection: for the given namespace, select the metrics that are applicable
dimension selection: for the given metrics, select the dimensions that must be set

This suggests a capabilities metadata hierarchy of three levels in which an LLM is invoked at each level to make a selection from a manageably sized database, and the result is used to select a preconfigured prompt at the next level. Consider this for a “brute force” scenario in which discrete metadata is literally created for every level. How many metadata files will we need?

This requires a total of 365 metadata files, and the hand linkage of them through URLs expressed in the children array. This is analogous to “hard coding” individual web pages when perhaps the pages should have been rendered dynamically from a database.

### Database Driven Hierarchical Templates

As mentioned earlier, the capabilities metadata is written using the StateD language. This immediately opens the possibility that a single template can be written for AWS CloudWatch metrics and that the template itself could encode the steps needed to produce the chain of reasoning, or to use any technology accessible over a network to answer the question without hallucination. For instance, the template could access a SQL database and can inject these functions into the template: $determineServices, $determineMetrics, $addDimensions. Each of these functions accepts the users message ($MESSAGE) and the chat output itself ($CHAT_OUT) so that the function can echo its chain of thought into the chat session. StateD templates are reactive, asynchronous data flows. So it is important to understand that the template below creates a reactive data flow. In fact, it is a workflow: $determineService→$determineMetrics→$addDimensions with each of the steps involving the LLM, custom prompting, and the exposure of chain-of-reasoning to the user.
name: AWS CloudWatch Health Rule Builder
breadcrumbs: [Home, Health Rules Builder]
capabilities: I
The Health Rules Builder page allows for manual or chat guided creation of health rules
services: ${$determineServices($MESSAGE, $CHAT_OUT)}
metrics: ${$determineMetrics($MESSAGE, $CHAT_OUT, services)}
dimensionedMetrics: ${$addDimensions($MESSAGE, $CHAT_OUT, metrics)}
prompt:
The user's message is ${$MESSAGE}. You will answer the user's message using JSON that adheres to ${schema}. You will build health rules using these dimensioned metrics: ${dimensionedMetrics}
schema: ${$fetch (′https://github. com/geoffhendrey/jsonataplay/blob/main/health_rules_list.schema. j son′)}

With this system, the AlertD chat agent can even identify 3rd party agentic capabilities bundled into 3rd party applications. For instance, consider a 3rd party application created to provide insights into mongoDB-performance, troubleshooting, and optimization. Using StateD templates, as illustrated above, the MongoDB App can build prompts on the fly, that can dynamically download the correct mongoDB documentation, specific to the user's question, and load it into the prompt on the fly. In fact, not only can the prompt be dynamic, but the capabilities text itself can be continually enhanced through network fetching of a capabilities document. This enables the MongoDB app to expand its capabilities over time without any kind of upgrade or reinstall process.

### UI State Management

AlertD provides a pervasive/omnipresent chat agent. The agent is responsive to performing tasks and answering through a combination of words, inlined micro-user interfaces, and by directly modifying the user interfaces seen by the user. At the time of this writing there are no known user interfaces in products that are equally responsive to both chat and graphical interaction. However, in order to provide an application such as the systems and methods described herein, it has been found that it is highly desirable to allow users, without limitation, to directly modify a UI (for example by clicking “+” to add a health rule) in the traditional UI interaction paradigm, but also without limitation to say to the chat “add a health rule”.

The problem that occurs is how to share a state between the chat session and the user interface, so that both the UI and the chat are operating on the same state. This is actually far more complex than simply thinking of the chat as a distinct user interface operating on shared state. The reason for this, is that a traditional UI only allows the user to interact with the visible state. This is obvious. However, a chat session has no such “WYSIWYG”. Users might ask the chat to make any form of modification or interaction to what they visually see, but they equally well may issue a request or query that is best served by some totally different part of the user interface than what they are currently viewing. Here are a examples of the types of challenges that occur when a chat is expected to navigate and interact with the user interface on behalf of the user.
How to convey the current user interface state to the chat agent? When a question is asked in the chat, how does the chat agent ‘know’ what is currently displayed on the screen and if the question is pertinent to what is currently seen on screen or not?
How to allow the chat agent to answer via a combination of words in a chat session AND ‘native’ user interfaces? A user might ask a question, “what is the current value of Bytes Uploaded for ml_recommender_models?”. A skilled SRE might recognize the question as being a form of shorthand for “What is the current AVG value of the AWS CloudWatch metric named BytesUploaded for bucket ml_recommender_models”. The best way to “answer” this question may be to present either a chat-inlined metric sparkline, in the chat session itself, or to redirect the user interface of the product to a portion of the product that displays the metric in question, or simply to say with words “the current value is 250 kb per second”. Or, some combination of these.

UI Structure Binding is an agentic prompt engineering technique developed by AlertD in which the current state of the currently displayed user interface is added as a preamble to LLM conversation. LLM Structured Output is another key piece. Structured Output is a technique in which the LLM itself is instructed to return only in adherence to a JSON schema, not as freeform user text. To combine these techniques effectively, AlertD has created an JSON based “intermediate representation” (an IR) which focuses on the structural content of the user interface, while minimizing stylistic/non-structural/non-content ‘noise’. It is important to have a high entropy IR because LLMs are limited in their token content windows. We have also found experimentally that the larger the prompt the higher the probability that generated content drifts from the desired intent as the LLM becomes “lost” in the prompt noise.

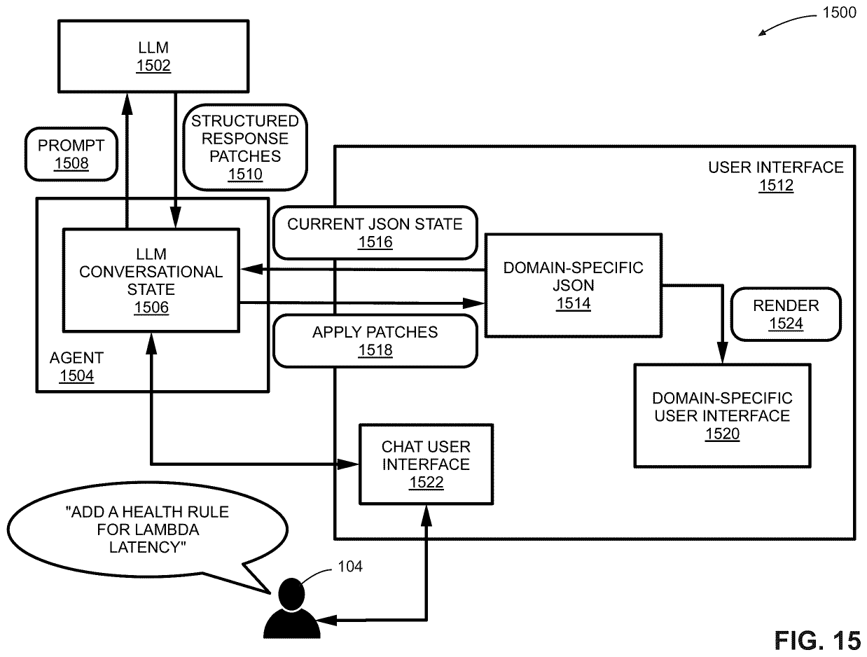

FIG. 15 is a block diagram depicting a computer architecture 1500 configured to process a user input from user 104. Computer architecture 1500 may be implemented using/on computing system 102, and configured to provide user interface (UI) structure binding. As depicted, computer architecture 1500 includes an LLM 1502, an agent 1504 that further includes an LLM conversational state 1506, and a user interface 1512. User interface 1512 may be implemented by user computing system 102, on browser 106. User interface 1512 may further include a domain-specific JSON 1514 (e.g., health rules), a domain-specific user interface 1520 (e.g., health overview tiles), and a chat user interface 1522.

In an aspect, user 104 may request, “Add a health rule for Lambda Latency” from computing system 1500. This request may be received from user 104 via chat user interface 1522. Chat user interface 1522 may route this request to LLM conversational state 1506, which may further route the request as prompt 1508 to LLM 1502. LLM 1502 may process prompt 1508 (i.e., the request from user 104), and provide one or more structured response patches 1510. These structured response patches 1510 may be received by LLM conversational state 1506, and applied as patches 1518 to domain-specific JSON 1514. Domain-specific JSON 1514 may further communicate a render 1524 to domain-specific user interface 1520. In addition, LLM conversational state 1506 may receive a current JSON state 1516 from domain-specific JSON 1514. This current JSON state 1516 may be further used by LLM 1502 to generate structured response patches 1510. The structured response patches 1510 may also be provided to user 104 by LLM conversational state 1506 via chat user interface 1522.

FIG. 15 illustrates how every page of the AlertD user interface is represented Domain Specific JSON document 1514. The AlertD agentic framework (i.e., computer architecture 1500) composes a prompt to the LLM 1502 consisting of a high entropy description of the current state JSON (1516), and instructions to respond in terms of JSON patches 1518 that make modifications to the JSON document. The end user 104 can make arbitrary requests from the chat such as “add a health rule for lambda latency”. The AlertD agentic framework combines current UI JSON state 1516, and the conversational chat into a prompt 1508, which the LLM 1502 responds to with patches 1518 to the JSON state. In so doing, the response from the LLM 1502 can include both “ordinary” chat responses, and/or accompanying changes to the visual user interface (e.g., render 1524). This provides dramatic benefits, especially for new users as they can use ordinary language to request changes to a user interface, without learning complex tools like dashboard editors. In fact, it opens the door to a dynamic alternative to dashboards, in which users are not asked to pre-imagine the their data display needs. Traditional dashboarding requires such “pre-imagining” and it is the reason large enterprises can have thousands of dashboards across dozens of teams. With AlertD, the time to build a dashboard is so low that dashboards and visualizations can be built on the fly, even in war-room situations.

### Runbook Synthesis

### Naming and Identifying

In an aspect, there are three equivalent ways to identify a Template. Each way specifies a fully qualified Template name. Consider a namespace foo containing an object bar/baz.txt with a version 1.2.1.
object style-
with explicit version-{namespace: foo, name: bar/baz.txt, version: 1.2.2}
with latest version-{namespace: foe, name: bar/baz.txt, version: latest}
with implied latest version-{namespace: foe, name: bar/baz.txt}
array style-
with explicit version-[foo, bar/baz.txt, 1.2.2]
with latest version-[foe, bar/baz.txt, latest]
with implied latest version-[foe, bar/baz.txt]
string style-
with explicit version-@foo/bar/baz. txt@1. 2.2
with latest version-@foo/bar/baz. txt@latest
with implied latest version-@foo/bar/baz. txt

### Application Framework

A key design choice of AlertD's design is that both backend data processing and frontend UI data manipulation is performed with StateD templates. This allows for an extensible system, both frontend and backend where 3rd parties can share applications on the AlertD Exchange and those applications can perform complex processing as well as sophisticated data display. Applications created by 3rd parties have the same first-class capabilities as pieces of the AlertD Application created by AlertD internal developers. Let's review some definitions.
Template—A template is a StateD JSON or YAML file containing dynamic expressions using classing shell variable syntax (${ }). A template is simply source code. It is never “live” or “running”. Templates are included in applications. Templates have these required sections:
   SpecVersion—Optional, defaults to ‘latest’. The version of the Template format itself.
   version—The version of this Template. It is under control of the developer control and should follow semantic versioning standards.
   kind: a reference to a JSON schema that instance objects must adhere to. Adherence is enforced after the StateD expressions in the object have been evaluated.
   metadata: information about the object
   object: an object that adheres to the kind's schema
   props: an object containing default props that can be consumed by the object
Component—A Template having a propsSpec in its metadata, which define publicly accessible “props” that define a clear interface to a template, in much the same way as React Props provide a clear interface to a component that has a complicated but hidden inner state.
Instance—A running instance of an object (think of the Template as the Class of an instance).
Application—A collection of Templates bundled together for a collective purpose. A tenant can subscribe to an application which makes the application's functionality available in the tenant.
namespace—A globally unique string beginning with “@” such as “@alertd” or “@coke” or “@pepsi” or “@pepsi-eu”
principal—An entity associated with a namespace of the form, <name><namespace>—for example “fred@coke”—that can be authenticated and authorized to perform. classification—one of UI I daemon that identifies if instances run in the backend or browser. In the future classifications could be expanded to encompass finer granularity isolate-one of appItenant Iuser
cardinality—combined with isolate, informs the system how many instances should be created in the given isolate. For example, allowing an app to specify that each tenant has a single instance.

### Template Runtime

In the section above, templates have been described. As the name implies, a template is a recipe for producing an actual object. A single Template, for example for downloading CloudWatch metrics, can be parameterized and instantiated thousands of times, each time with different parameters. The instantiated objects exist inside a template runtime. The particular runtime is less important than understanding that no matter where the runtime instances are executed, that there must be a system of metadata that tracks which instances exist, and how to locate their runtime container.

In an aspect, “running instances” are represented by metadata, and do not have an object field. This is because instances (running objects) exist inside a runtime referred to as a TemplateProcessor and are dynamic objects, constantly reacting to changing data that they ingest. A “pointer” to these running objects may be stored but the running instance itself is either passivated as a snapshot or active in a TemplateProcessor.

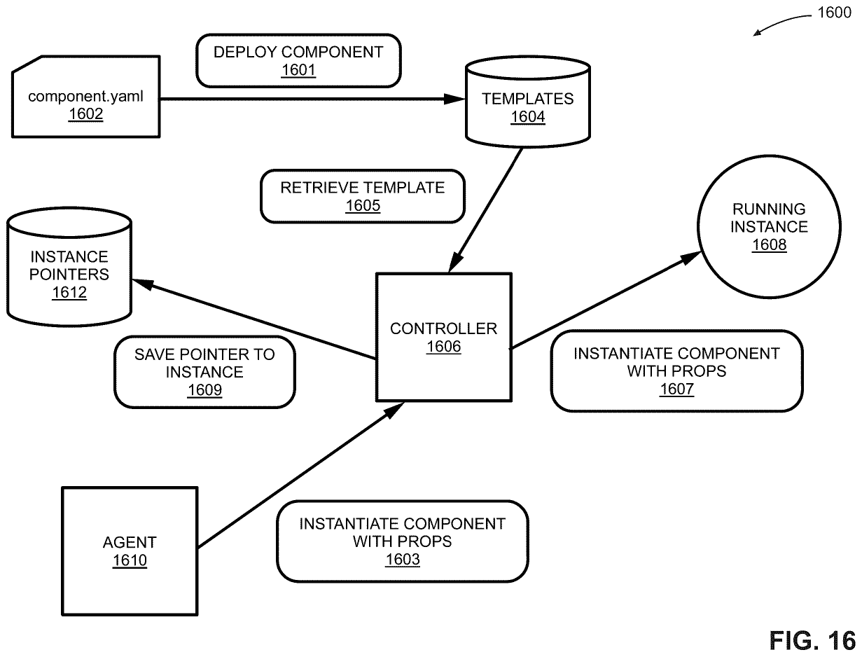

FIG. 16 is a schematic diagram illustrating a template lifecycle 1600. In an aspect, a template lifecycle may include:
Component Template being defined in an application YAML file 1602. The template is deployed 1601 to a registry (e.g., templates 1604) using a registry API command.
A client sending a request to a runtime controller 1606 for instantiation of component with props 1603.
Controller 1606 retrieving the template 1605 from registry 1604.
Controller 1606 instantiating runtime instance of component with props 1607 to generate running instance 1608, and recording locator information (i.e., saving pointer to instance 1609, to instance pointers 1612).

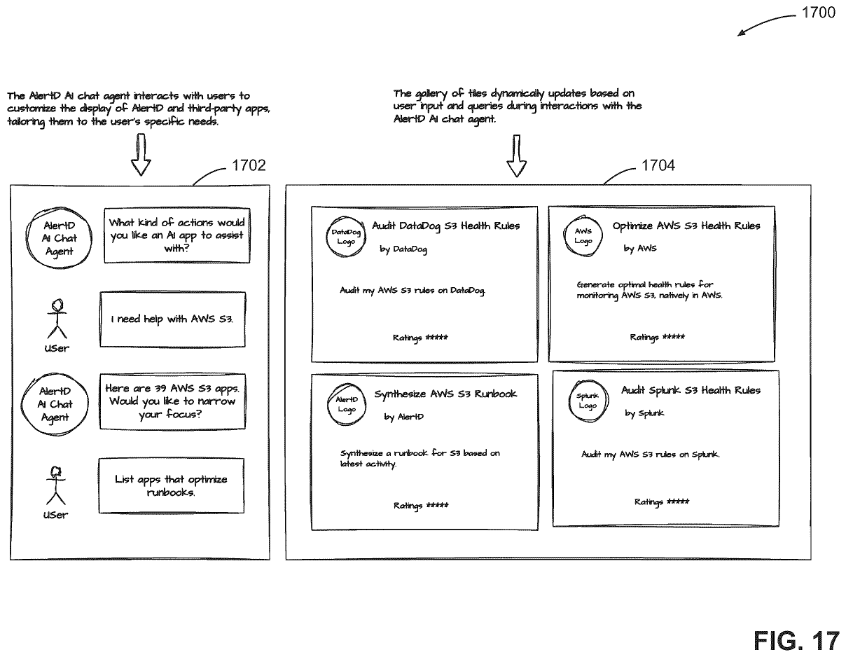

FIG. 17 is a schematic diagram illustrating a natural language chat interface 1700. Natural language chat interface 1700 may be used to implement an interactive interface between a user (e.g., user 104) and a gallery providing one or more application choices. In an aspect, and AlertD AI chat agent (e.g., as deployed in agents 222) interacts with users to customize the display of AlertD and 3^{rd} party apps, tailoring them to the user's specific needs (1702). In response to the user needs/inputs, the gallery of tiles (i.e., available apps) dynamically updates based on user inputs and queries during interactions with the AlertD chat agents (1704). In an aspect, natural language chat interface 1700 provides user 104 with an App Exchange.

### App Exchange:

In an aspect, computing system 102 also supports delivering a gallery of AI agent applications accessible to enterprise users (e.g., natural language chat interface 1700). The computing system 102 is designed to centralize AI-driven functionalities into a single platform, making it easy for users to discover, deploy, and interact with intelligent agents tailored to their operational needs. These agents, developed either by the system provider (e.g., AlertD) or by third-party vendors, are housed within a centralized gallery (e.g., 1704). This gallery acts as a repository of tools offering diverse functionalities, including but not limited to rendering visualizations and dashboards, automating workflows, generating personalized and synthesized runbooks, creating system health rules, and optimizing various enterprise processes. By consolidating these capabilities into a unified system, the invention significantly enhances accessibility and operational efficiency for organizations.

One component of this system is the marketplace interface, which allows users to browse and subscribe to the Al agents they need. The marketplace is designed to provide transparency and convenience, offering detailed descriptions, functionalities, and integration options for each agent. Once subscribed to, these agents can be seamlessly deployed within the user's existing enterprise environment. The marketplace ensures compatibility between the selected agents and the organization's operational infrastructure, reducing friction and simplifying the integration process.

Another feature of the system is the natural language chat interface 1700, which provides an intuitive way for users to interact with the Al agents. Instead of requiring technical knowledge or complex commands, users can communicate with the agents using conversational language. This interface supports queries, commands, and customizations, enabling users to access and leverage the agents' functionalities effortlessly. For example, a user might ask an Al agent to generate a custom dashboard, automate a repetitive workflow, or synthesize a runbook for a specific incident, all through simple conversational input.

An aspect includes a robust integration framework that facilitates the seamless deployment of AI agents into enterprise environments. This framework ensures that the agents can retrieve and process data from existing systems, execute tasks, and provide outputs tailored to the organization's needs. By supporting interoperability across diverse systems, the framework enables the agents to function as an integral part of the enterprise infrastructure, thereby maximizing their utility.

In addition to individual functionalities, the system emphasizes workflow optimization by enabling the AI agents to perform tasks such as identifying inefficiencies, automating routine processes, and delivering actionable insights. For instance, agents can analyze operational data to generate system health rules, predict potential issues, and recommend preventative measures. These capabilities empower organizations to proactively manage their operations, improve decision-making, and enhance overall performance.

One aspect is designed to address the growing need for personalized and scalable solutions in enterprise environments. By centralizing Al-driven tools in a user-friendly gallery, equipping them with natural language interaction, and ensuring seamless integration, this system bridges the gap between advanced Al functionalities and practical enterprise applications. The result is a transformative platform that enhances workflow efficiency, reduces manual effort, and delivers measurable value to organizations across industries.

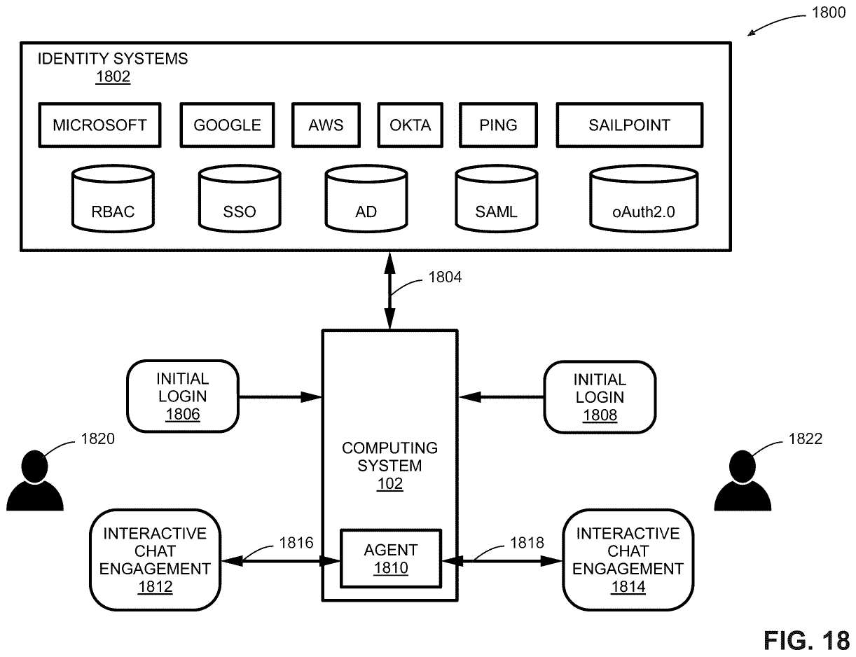

FIG. 18 is a block diagram depicting a computer architecture 1800 that includes a conversational chat agent. Computer architecture 1800 includes computing system 102 interfaced with one or more identity systems 1802. Identity systems 1802 may include Microsoft, Google, AWS, OKTA, Ping, SailPoint, RBAC, SSO, AD, SAML, and oAuth2.0, configured to provide user identity storage and user identity validation services. Computing system may retrieve one or more user profiles from identity system 1802 to obtain contextual information (1804). A software engineer 1820 may perform an initial login 1806, which is verified 1804 by computing system 102 using identity systems 1802. A security engineer 1822 may perform an initial login 1808, which is verified 1804 by computing system 102 using identity systems 1802.

Computing system 102 may identify that software engineer 1820 and security engineer have different interaction requirements with computing system 102. Accordingly, agent 1810 (e.g., an agent 222) provides a distinct interactive chat engagement 1812 and 1818, to software engineer 1820 and security engineer 1822, respectively. In essence, computing system 102 provides a personalized agent and associated user interface to each user based on the respective user role.

### Personalized Agents

In an aspect, computing system 102 deploys Al agents (e.g., agents 222) that dynamically personalize their communication style and language based on the roles and personas of the users they interact with (e.g., agent 1810 provides a unique chat interface to each of user 1820 and user 1822). These Al agents, developed by AlertD, integrate natural language processing (NLP) capabilities with enterprise identity systems, such as Role-Based Access Control (RBAC), Single Sign-On (SSO), and other identity management platforms, to obtain contextual information about a user's role and responsibilities. This contextual data allows the agents to tailor their language, tone, and content to align with the user's specific expertise and needs. For example, computing system 102 may interact with security engineer 1822 and software engineer differently 1820, using security-focused terminology and threat analysis for the former while providing application-level insights and recommendations for the latter. This dynamic adaptation ensures that each user receives information in the most effective and comprehensible format for their role.

Some aspects include the use of persona profiles, which are created and maintained by the Al agents (e.g., agents 222). These profiles are generated using data from enterprise identity systems and are dynamically updated based on the agent's interaction history with the user. Persona profiles capture critical attributes such as the user's technical domain, role-specific requirements, and preferences, allowing the agents to refine their communication further over time. This ensures that interactions remain consistent, accurate, and increasingly relevant as the Al agents learn from user behavior. Furthermore, the system supports multi-role interactions, enabling the AI agents to adapt communication for multiple users with differing roles simultaneously. For example, during a collaborative incident management effort, the agent can provide a security-focused analysis for a security engineer while delivering high-level technical recommendations for a software engineer. This multi-role adaptability fosters seamless collaboration, reduces communication gaps, and ensures that all stakeholders are well-informed and aligned.

The system enhances preventive incident management by delivering proactive recommendations tailored to each user's responsibilities and technical background. Security engineers, for example, might receive guidance on access control improvements or vulnerability patches, while software engineers might be directed to update dependencies or optimize application performance. This targeted communication ensures that preventative measures are implemented efficiently and accurately, reducing the likelihood of future incidents.

The Al agents also feature natural language chat interfaces, enabling users to interact conversationally without requiring technical expertise or complex commands. Users can easily access critical information and functionality through intuitive queries, requests for synthesized runbooks, or prompts for prescriptive steps. This conversational interface improves system accessibility, making it user-friendly for individuals across a diverse range of roles within an organization. Additionally, the system includes a robust integration framework that ensures the Al agents can seamlessly interact with existing enterprise environments. This framework allows the agents to access and process data from identity systems and enterprise applications, execute tasks aligned with user roles, and deliver outputs tailored to organizational workflows. By supporting interoperability, the system ensures that Al agents are fully integrated components of the enterprise infrastructure, maximizing their utility and impact.

By dynamically tailoring communication to user roles and personas, this invention addresses the critical need for clear and effective communication across diverse teams in modern enterprises. Role-specific language personalization reduces misunderstandings, accelerates decision-making, and improves the efficiency of incident management workflows. Whether addressing preventive measures or resolving active incidents, the AI agents streamline collaboration and ensure all users are supported in their unique responsibilities. This invention represents a transformative advancement in Al-driven enterprise tools, combining the capabilities of enterprise identity systems, natural language processing, persona profiling, and seamless integration to bridge communication gaps, deliver actionable insights, and foster more effective incident management processes. The result is a highly adaptable system that enhances operational efficiency, improves collaboration, and ensures optimal workflow performance in enterprise environments.

Programable Core Platform with StateD

StateD is an open source project that plays an import role in ensuring that AlertD is a “programable core”. StateD is used for data processing on the backend and frontend of AlertD. The choice of StateD is important, because it means that nearly every capability of the platform, as well as those capabilities that AlertD has not yet envisioned, are accessible to 3rd party developers. Safety/Security are an important benefit of exposing StateD as the interface to 3rd party developers. StateD is inherently “sandboxed” and high level—it does not allow raw access to the DOM which languages like JavaScript allow. This means that a StateD based dashboard running in the customer's browser 106, supplied by a 3rd party app, cannot capture and exfiltrate JWT tokens. Nor can a StateD program execute low level attacks against the operating system.

The system architecture described above shows that the following capabilities of the system are implemented as StateD templates, and that 3rd parties can provide additional templates as parts of their applications, offered for subscription on the app exchange:

Metric Derivation—Metric derivation is the process of using APIs that are not metric APIs at all, and massaging their content, often making multiple API calls connected as a workflow, to achieve an end result (an output) that is a metric. For example, there is no AWS CloudWatch metric that counts 53 files whose size is larger than 100 MB. However, such a metric can by derived by building a workflow that queries the aws s3 list API, paginates over the pages of results using successive API calls, and filters for files larger than 100 MB. Running this workflow every 60 seconds can produce a metric statistic, such as the count of files larger than 100 MB.

Health Rules—Health Rules are used to examine metric signals and SDLC events. Health rules can use any form, of logic, including agentic reasoning, to determine the current health of a the system, or subsystem, and to determine whether to raise an alert based. As described above, the SDLC event stream passes through a sliding window configurable to n-events or t-time in width. The sliding window (an array of objects) is accessible to health rules. In the reactive-dataflow paradigm of StateD, when the sliding window content changes, the health rule StateD DAG is automatically re-evaluated, evaluating only those statements that depend on the event window. In this fashion, health rules can easily include declarative language to perform complex event processing efficiently.

UIs and Dashboards—All pages (Uls) of the AlertD application are implemented as StateD templates that emit a JSON based description of visual content. There is no structural difference between a “built in” StateD page, and a dashboard created by a customer or bundled into a 3rd party application. A AlertD dashboard is far more capability rich than a traditional Grafana or Splunk dashboard, because the dashboard author (human or AI/LLM) can leverage the complete data processing and manipulation powers of StateD, without having to develop custom React components. Dashboards can call out to 3rd party APIs and internal APIs the same way as general purpose workflows can.

Agents—Agents (e.g., agents 222) are “personalities” capable of conversing with the AlertD user through the chat feature of the AlertD UI. AlertD has an agentic framework allowing 3rd parties to create agents with domain specific knowledge and databases. These domain-specific agents can be called in on-demand by either the AlertD agent, or the user. These agents provide bundled databases as part of the AlertD agentic prompt framework, that reduce hallucination for deeply domain specific tasks, such as trouble shooting a MongoDB clustered deployment.

Workflows—What does it mean that AlertD offers these kinds of templates written in StateD? It means that elements of the AlertD backend and frontend are designed to operate on objects that conform to a domain-specific structure, such as visual dashboard layout structure, or domain specific health rules structure. Each of the 5 AlertD systems above has its own “kind”; a JSON schema that instructs template authors (both human and LLM) what the acceptable object structure us for the template to generate. By building StateD templates that emit objects in adherence with these JSON schemas, 3rd parties can add additional derived metrics, health rules, Uls and Dashboards, agents, and workflows to the platform. This creates a powerful mechanism for comprehensive vertical applications to be built atop AlertD.

### Metric Derivation Workflows

The figures above illustrate that health rules can be driven by conditions applied to metrics. However, experience with early prospect customers showed us that traditional metrics do not capture many real situational indicators. For example, consider the situation of a self-driving car company and a problem caused by their build system. When the build deposits files into S3, as part of the software update package for a vehicle, it sometimes happens that files are deposited which exceed the 400 MB maximum allowable size of a single file that the vehicle's OTA loader can handle. When this happens it is catastrophic because the entire fleet must have every car's loader manually reset which causes loss of 24 hours drivetime for the entire fleet. For this reason it is critical that such “bad builds” get detected quickly. Unfortunately there is no CloudWatch metric that measures counts of files greater than a particular size.

In implementations, StateD templates are ideal for polling APIs and transforming data received from those APIs into metrics. For example, a StateD template, continuously polling AWS S3 list APIs can produce a metric that counts the number of files whose size is greater than 400 MB. Essentially, metric derivation is a subset of custom workflows. Any workflow that produces a metric is by definition a metric derivation workflow.

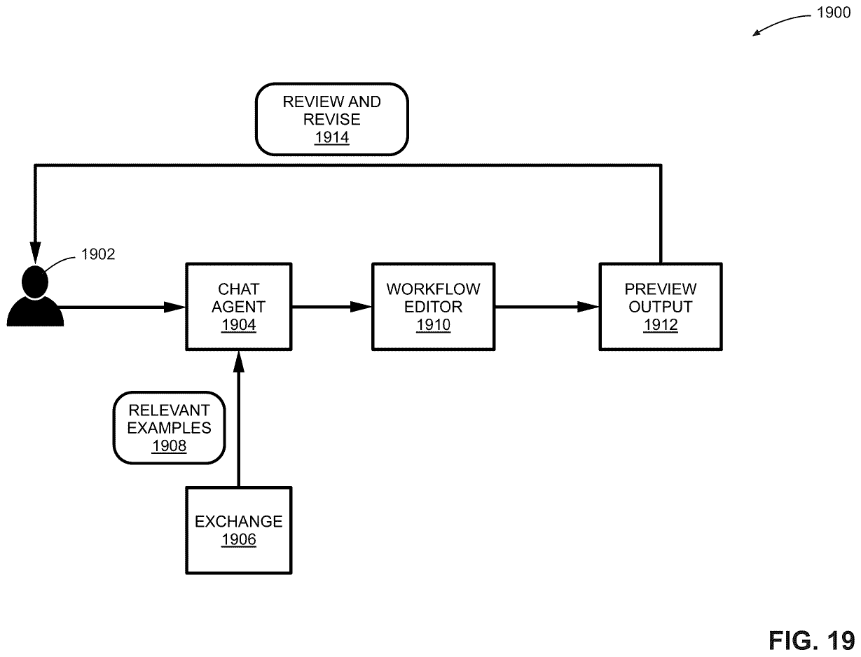

FIG. 19 is a block diagram depicting a user interaction 1900 with a chat agent. As depicted, a user 1902 presents an input (e.g., a request in natural language format to chat agent 1904). Chat agent 1904 draws one or more relevant examples 1908 from exchange (repository) 1906. The chat agent 1904 processes the user input with the relevant examples 1908 and outputs the result to a workflow editor 1910. The workflow editor 1910 outputs the results to a preview output 1912 for user 1902 to review and revise (1914). User interaction 1900 is an example of AI-generated StateD.

Recent developments in LLMs have introduced the concept of “Function Calling” which purports to give LLMs the capability to understand APls and follow high level instructions for accessing these APls. Supposedly the LLM can follow complex instructions and translate these to functions calls, extraction and manipulate of resulting data, and subsequent chaining of more function calls. Frameworks like LangGraph assist with it. Essentially, function calling purports to allow an LLM to act as a workflow engine. AlertD's internal experiments showed that Function Calling with LangGraph fails to work reliably for even the most basic scenarios crafted around simple requests. The LLMs failed on basic scenarios regardless of whether OpenAI, llama, FireFunction or Mistral Nemo were used-all LLMs that are supposedly optimized for function calling.

Fortunately LLMs are very good at emitting declarative instructions, such as StateD templates. This allows AlertD's Al Agent to assist users in creating workflows. Examples from the AlertD exchange are used to seed the LLM with relevant examples.

### AlertD Backend Details

AlertD's backend is essentially a multitenant controller for StateD templates. Templates are bundled together into logical units called Applications (i.e., Apps). Most “built-in” functionality of the AlertD application is internally packaged as Apps using the same mechanisms available to end users.

As described in the section on Application Framework, AlertD Templates have a corresponding isolate that allows Users, Tenants, and Applications to securely co-exist.Isolates define default isolation/access control rules:
App isolation-applications cannot access data from other apps
Tenant isolation
   Tenants cannot access data from other tenants
   Tenants cannot access data from apps they are not subscribed to
   Tenants cannot access data from users that are not members of their tenant
User isolation
   Users cannot access data from tenants they are not members of
   A user cannot access data from an app, unless the user is a member of a tenant that subscribes to said app
   User A cannot access data from user B unless A and B are members of the same tenant
   User A cannot access data from user B unless B's data is shared with User A

In an aspect, AlertD's data ingestion and streaming architecture is a distributed Directed Acyclic Graph (DAG) consisting of shared-nothing local DAGs that are interconnected via the streaming of atomic change sets.

This architecture is quite different than architectures like KStreams or Flink because StateD templates are easy to write, and easy to manage in git repositories. The declarative JSON/YAML design of StateD means that LLM's are able to craft StateD templates.

### Fault Tolerance

In order to provide reliability and high availability, DAGs must be able to fail, remain offline for a reasonably long period of time, and then rejoin. This is accomplished through the use of Pulsar as a streaming fabric for Atomic Change Sets, and using S3 to provide checkpoints that can be used to restore state on DAG recovery.

### Node Placement

DAGs are instances of stated templates, instantiated with a certain set of parameters. For example, logically a template named MetricFetcher.json could exist as two distinct runtime TemplateProcessors. The command below starts the MetricFetcher template, and injects a different array of s3 metrics into each instance:

stated Metricfetcher. json - - - ctx.inputs name = “byte
metrics” - - - ctx.metrics. s3 = [
“BucketSizeBytes”, “BytesDownloaded” ] ;
stated Metricfetcher. json - - - ctx.inputs name = “http
method metrics” - - - ctx. metrics. s3 = [ “Al
IRequests”, “GetRequests”, “PutRequests”];

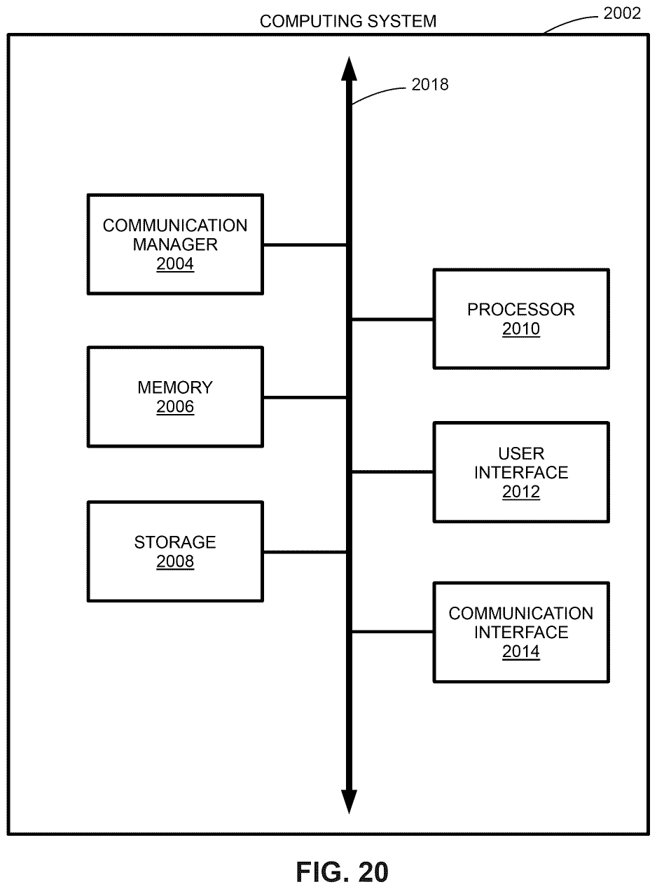

FIG. 20 is a block diagram depicting a computing system 2002. Computing system 2002 may be used to implement embodiments of computing system 102. As depicted, computing system 2002 includes communication manager 2004, memory 2006, storage 2008, processor 2010, user interface 2012, communication interface 2014, and bus 2018.

In some embodiments, communication manager 2004 is configured to manage communication protocols and associated communication with external peripheral devices as well as communication with other components in processing system 2002. Memory 2006 may be configured to store data associated with computing system 2002. In one aspect, memory 2006 includes both long-term memory and short-term memory. Memory 2006 may be comprised of any combination of hard disk drives, flash memory, random access memory, read-only memory, solid state drives, and other memory components.

In an aspect, memory 2006 includes a non-transitory computer medium. Memory 2006 may be comprised of any combination of volatile and non-volatile memory components. Examples of components that may be used to implement memory 2006 include random-access memory (RAM), read-only memory (ROM), electrically-erasable programmable read-only memory (EEPROM), flash memory, magnetic memory, optical memory, and so on. Memory 2006 may include machine-readable instructions that may be executable by a processor such as processor 2010. These machine-readable instructions when executed by the processor 2010 cause the processor 2010 to perform one or more method steps of an embodiment described herein.

Computing system 2002 may include storage 2008, that further includes one or more long-term storage devices such as hard disk drives, magnetic drives, magnetic tape, optical storage media (e.g., compact disks (CDs) or digital versatile disks (DVDs)), and so on. Storage 2008 may be implemented as a non-transitory computer-readable medium. Storage 2008 may be configured to store data and/or instructions related to the operation of computing system 2002.

A processor 2010 included in some embodiments of computing system 2002 is configured to perform functions that may include generalized processing functions, arithmetic functions, and so on. Processor 2010 is configured to process information associated with the systems and methods described herein. Processor 2010 may be configured as any combination of microcontrollers, microprocessors, digital signal processors (DSPs), field-programmable gate arrays (FPGAs), graphics processing units (GPUs), accelerated processing units (APUs), central processing units (CPUs), application-specific integrated circuits (ASICs), and so on. Processor 2010 may be embodied as a single-core processor, or a multi-core processor. Processor 2010 may be implemented as a centralized processor, or in a distributed manner (e.g., a distributed computing system).

User interface 2012 allows a user to interact with embodiments of the systems described herein. User interface 2012 may include any combination of user interface devices such as a keyboard, a mouse, a trackball, one or more visual display monitors, touch screens, incandescent lamps, LED lamps, audio speakers, buzzers, microphones, push buttons, toggle switches, and so on.

Communication interface 2014 may be used to interface computing system 2002 with other computing devices and/or computer networks. Examples of computer networks include a local area network (LAN), a wide area network (WAN), the Internet, and so on. Communication interface 2014 may support any combination of wired and wireless connectivity/communication protocols such as Ethernet, Wi-Fi, Bluetooth, ZigBee, etc. may be used to interface computing system 2002 with other computing devices and/or computer networks. Examples of computer networks include a local area network (LAN), a wide area network (WAN), the Internet, and so on. Communication interface 2014 may support any combination of wired and wireless connectivity/communication protocols such as Ethernet, Wi-Fi, Bluetooth, ZigBee, etc. Bus 2018 communicatively couples and allows for communication between the different components of computing system 2002.

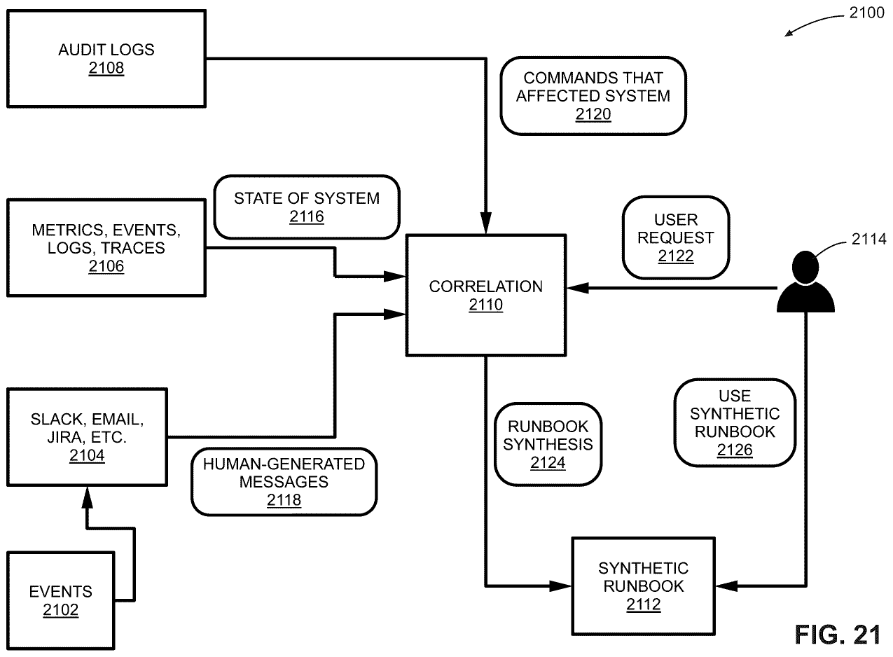

FIG. 21 is a block diagram depicting a computer architecture 2100 configured to perform a correlation operation. In an aspect, the correlation operation is performed by correlation 2110, that may be implemented on computing system 102, to implement runbook synthesis 188.

Correlation 2110 may receive an array of signals from a plurality of signal sources. In an aspect, correlation 2110 receives one or more commands that have affected a system 2120, from audit logs 2108 (similar or identical to audit systems 130). Correlation 2110 may receive system state(s) 2116 from metrics, events, logs and traces 2106 (e.g., metric systems 154). Correlation 2110 may receive human-generated messages 2118 from systems like Slack, email, Jira and so on, 2104 (e.g., SLDC systems 108). The systems 2104 may themselves be driven by system-specific events 2102.

In an aspect, correlation 2110 receives a user request 2122 from user 2114 (similar to user 104). For example, user request may include user 2114 requesting correlation 2110 to help them resolve a problem with a recommender/service. In response to user request 2122, correlation 2110 performs runbook synthesis 2124 on signals 2120, 2116 and 2118, to generate a synthetic runbook 2112, which is used 2126 by user 2114 In an aspect, correlation 2110 is configured to determine correlations between signals 2120, 2116, and 2118. In one example, user 2114 is a site reliability engineer (SRE). User 2114 may use 2126 the synthetic runbook 2112 to resolve a problem or to repeat a task.

Runbook synthesis 2124 may present correlation results to user 2114 in the form of an interactive graphical user interface (e.g., an interactive user dashboard). A left-hand panel of this dashboard may include events 2102, that may further include one or more audit commands. A right-hand panel of this dashboard may include synthetic runbook 2112, or data from synthetic runbook 2112. A central panel of this dashboard may include a graphical presentation of a set of signals curated by correlation 2110 for review by user 2114.

In an aspect, runbook synthesis 2124 essentially correlates SDLC and other signals (e.g., signals generated by SDLC systems 108) with commands sent to the systems being observed. The commands are detectable in the audit logs of these systems. The actual API/CLI command and parameters can be extracted, and used to build a synthesized runbook of similar or related commands. This can be used to repeat the action or sequence of actions, or to execute a modified flavor of the actions, or to derive an undo/remediate sequence of actions.

FIG. 22 is a screenshot depicting a dashboard 2200. Dashboard 2200 may be presented to user 104 (or user 2114) to include runbook 2112. As depicted, dashboard 2200 includes a left panel 2202, a middle panel 2204, and a right panel 2206. The left-hand panel 2202 may include audit commands show up as green “play buttons”, meaning that these commands have been detected as are imperative commands. Right panel 2206 can be configured to present data related to synthetic runbook 2112. Middle panel 2204 may be configured to present correlation results from correlation 2110. In this regard, middle panel 2204 may display data similar to the correlation results presented in FIG. 5.

Al Analysis—In an aspect, left panel 2202 shows the AlertD Agent providing situational awareness through an analysis of the current system state, as understood through SDLC signals. The analysis includes:
a clear summary of a problem that occurred in the system
a clear explanation of which MELT signals, amongst the thousands available, were chosen for presentation in the Correlate panel

Visual Signal Correlation—Middle panel 2204 displays relevance-highlighted SDLC signals, and
signals have been curated by Al for relevance to the most important aspects of the current situation
a search feature allows the user to enter any form of search in natural language such as “the Jira ticket about the ML files that were too large”. The search feature results in re-analysis and re-curation of the screen.
signals include
   machine generated signals, like Jenkins build steps, or other logs
   human generated message, such as Slack
   audit logs that record commands, such as Cloud Trail and Kubernetes Audit Logs
signals are presented as time series, with relevance-coloring used to provide visual cues to the most relevant events
a vertical “time scrubber” is used to auto-scroll the Event Details panel thereby providing a clear linkage between the currently-examined time instant, and the specific events contained in the signal.

Event Details—The right panel 2206 may be an event details panel that shows a scrollable sequence of events.
Al-synthesized descriptions of each event are displayed
Events are curated-events shown in the events panel correspond to relevance-highlighted events on the central correlation screen
Event details can be displayed (e.g., the entire event source) by clicking on the event
Events are identified as relating to the root cause of a problem
Events are identified as being “commands” (a play button) which are critical for problem resolution and runbook synthesis

### Runbook Synthesis

One aspect displays results from an AI/LLM processing a sequence of events in right panel 2206, for the purpose of
summarizing the meaning of the event sequence
presenting the user with an option to synthesize a runbook
providing selectable views of events, inclusive of
   all events
   commands only—this view is useful for extracting commands, as a precursor to generating a runbook
   root cause only
   fix-related only
   any combinations of the above

Synthetic runbooks are focused on providing engineers with real actionable commands that can be used to resolve problems, and the ability to collaborate on the runbook.

In an aspect, the events and metrics to display in right panel 2206 are populated automatically by the runbook synthesis 2124. This is important because a typical large AWS account may have hundreds of thousands or even millions of metric timeseries stored in AWS CloudWatch. Today's typical approaches with Grafana style dashboards are “imagine in advance what you might want to observe to understand health, and to preconceive what you might need to observe in various unhealthy situations.” This imposes a huge toil cost. As shown in FIG. 22, the AI chat displayed in left panel 2202 explains to the user why certain events and metrics are relevant to the current situation. The current situation happens to have a problem or issue. Other instances of the dashboard 2200 may display data that includes healthy system data.

As shown in FIG. 22, events from left panel 2202 are mapped both to event details in right panel 2206, as well as signals depicted in a graphical format in middle panel 2204, using color coding to denote certain signal properties (e.g., signal health).

Some aspects include computing system 102 dynamically and responsively organizing and reorganizing, through a chat conversation with an agentic AI, a dashboard of metrics, events, logs, and traces (MELT) that provides quality evidence within limited screen real-estate (e.g., the dimensions and resolution of a visual display being used by user 104), to support the situational hypothesis presented by the AI. Some aspects include:
Formulation of a narrative explanation or hypothesis about the current system state in prose, typically markdown or chat messages; doing this continuously or on-demand; and/or doing this interactively in response to a conversation. Selecting the right signals and timeframes to support the hypothesis.
Including, in the narrative, explicit mention of said signals, anomalies or lack of anomalies in the said signals, and the meaning and relationships between said signals, system state/health or observed “situation”.

Other features implemented by computing system 102 include:
Correlate view presents a synthesized overall system health. This is the “high level” state, which compresses many signals into a single signal. This was also not feasible to do accurately pre-AI, because static rules lacked the flexibility and intuition to gauge “importance” in a way that humans can. LLMs have made this possible.
Correlate view presents color coded “Semantic” events. Semantic events are events that are semi-structured or unstructured, such as build messages on slack from Team City or Jenkins, as well as human-originated messages on slack. The ability to digest semantic messages, as opposed to codes and enumerations, provides for a greatly simplified user interface.

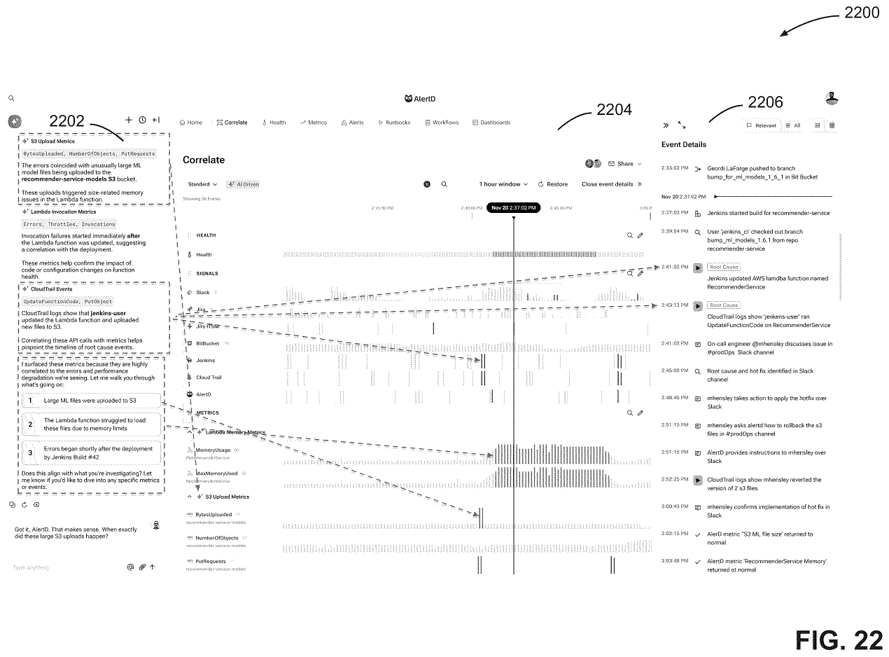

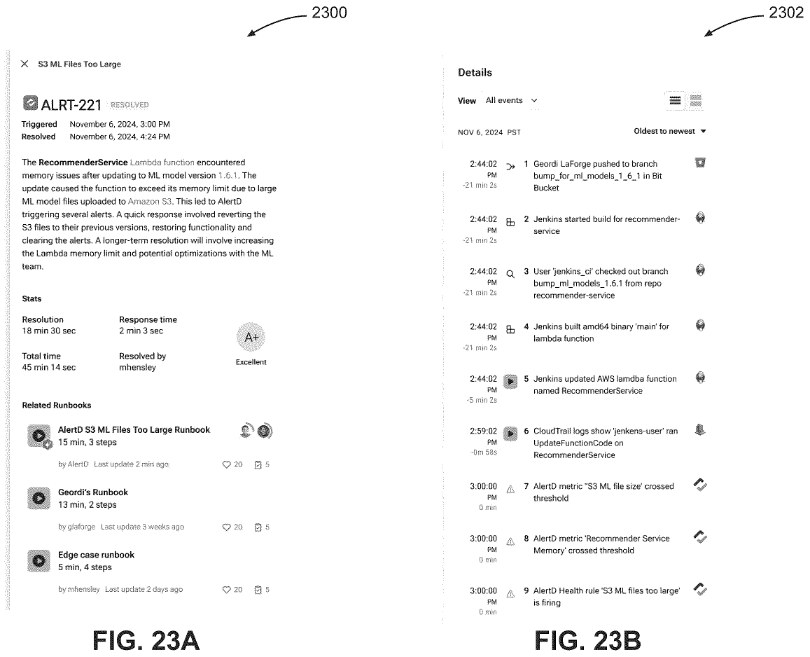

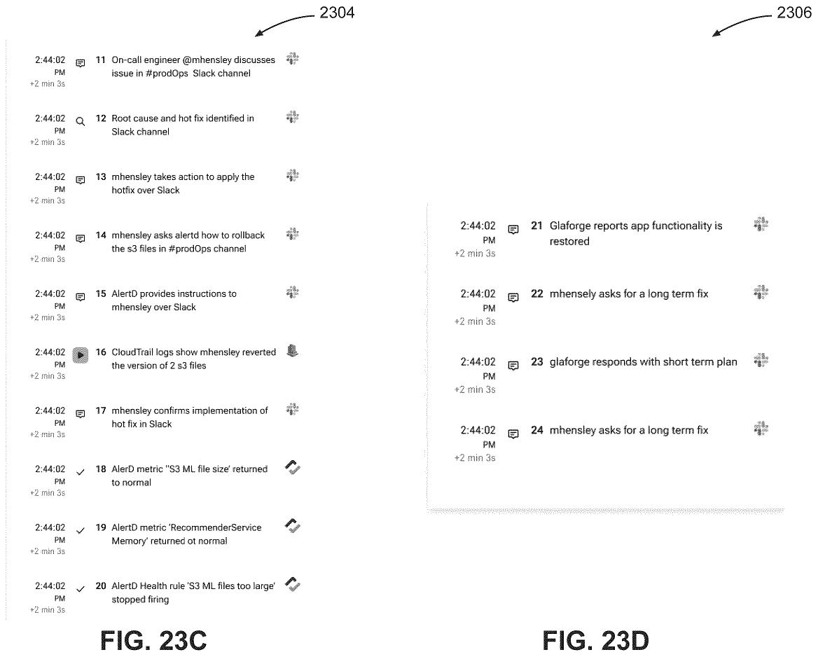

FIGS. 23A through 23D are screenshots of example events, such as events 2102. FIGS. 23A through 23D may represent user information that is included in the left panel 2202 of dashboard 2200. In an aspect, screenshot 2300 (FIG. 23A), screenshot 2302 (FIG. 23B), screenshot 2304 (FIG. 23C), screenshot 2306 (FIG. 23D), are discrete components of one single information set presented in left panel 2202.

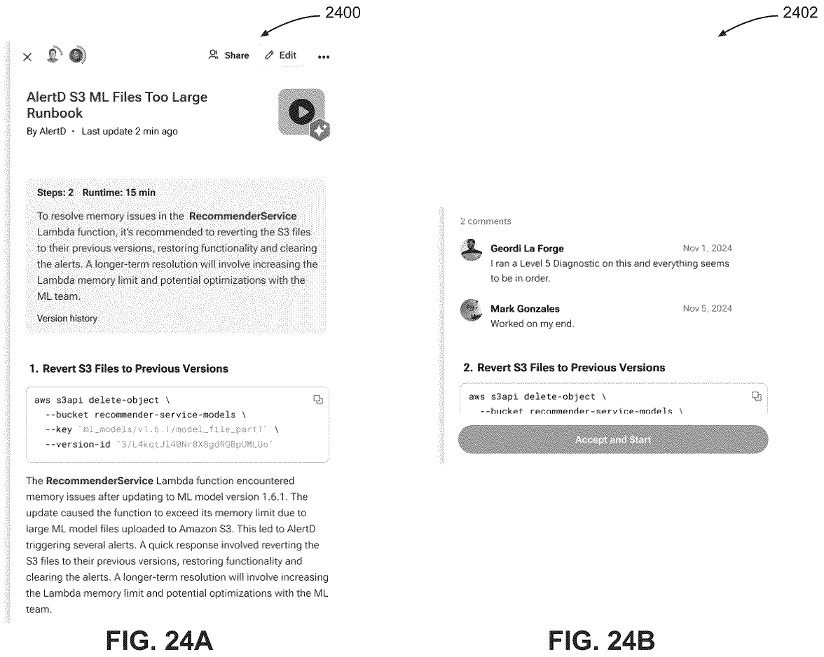

FIGS. 24A and 24B are screenshots of a synthetic runbook, such as synthetic runbook 2112. In an aspect, screenshot 2400 (FIG. 24A) and screenshot 2402 (FIG. 24B) are discrete components of one single information set presented in right panel 2206.

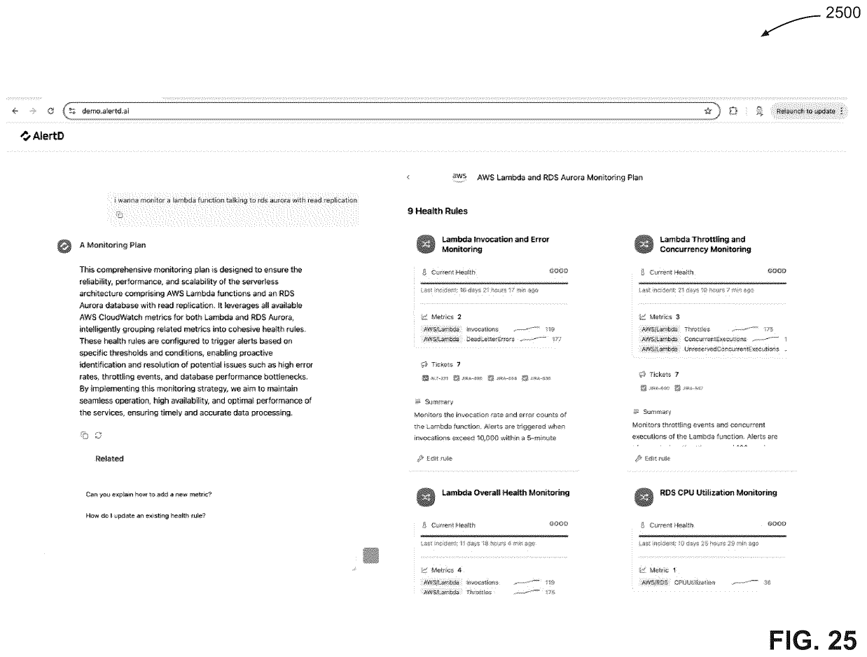

FIG. 25 is a screenshot depicting a synthesized monitoring and alerting plan 2500. Synthesized monitoring and alerting plan 2500 may be associated with an alert synthesis, as described subsequently.

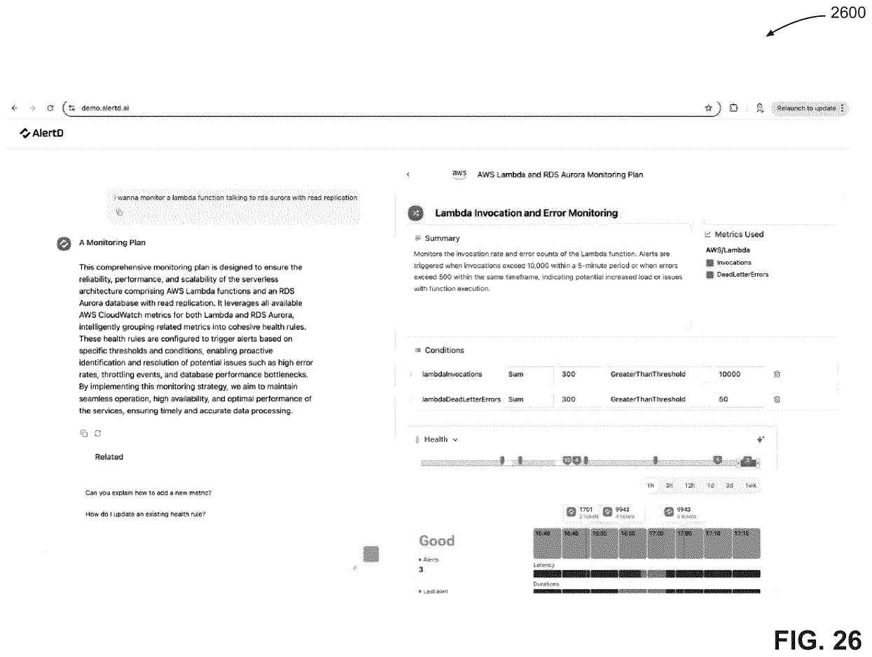

FIG. 26 is a screenshot depicting individual synthesized health rules 2600. Synthesized health rules 2600 may be associated with an alert synthesis, as described subsequently.

### Alert Synthesis

Alert Synthesis is the ability to review SDLC events, MELT, and direct conversation (chat) with end users, to build an optimal monitoring plan. In one implementation, an AlertD engages in a chat conversation with an end user to create an optimized set of Health Rules as part of a synthesized monitoring and alerting plan. Users are able to interact with Health Rules UI simply by entering chat messages such as “I don't want concurrent executions on my lambda throttling rule”. User interfaces associated with alert synthesis are presented in FIGS. 25 and 26.

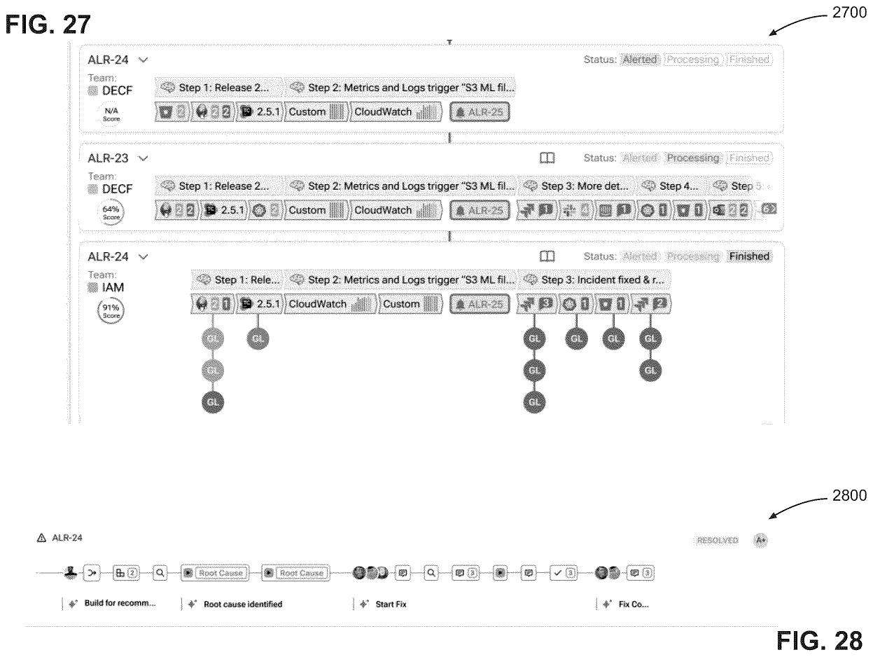

FIG. 27 is a screenshot depicting a subway view 2700.

FIG. 28 is a screenshot depicting a subway view 2800.

### Subway View

Subway view, as presented in FIGS. 27 and 28, is a view used to present sequences of SDLC events and MELT states as consolidated timelines using AI/LLM to group and summarize. Such views allow the leading indicators of problems, and a team's response to the problem, to be sequentially aligned and compared. In an aspect, a subway view shows a comparison of three situations where a given alerting rule (ALR-25) has fired. This view allows a user to understand:
why was my team's response faster in one case than another?
what engineer committed the code that caused the problem
when teams were involves in the response?

Subway views allow managers and interested parties to understand, learn from, and measure a team's ability to respond. LLM is used to group together related events and provide high level descriptions of the synthesized steps such as “incident fixed & root cause identified”.

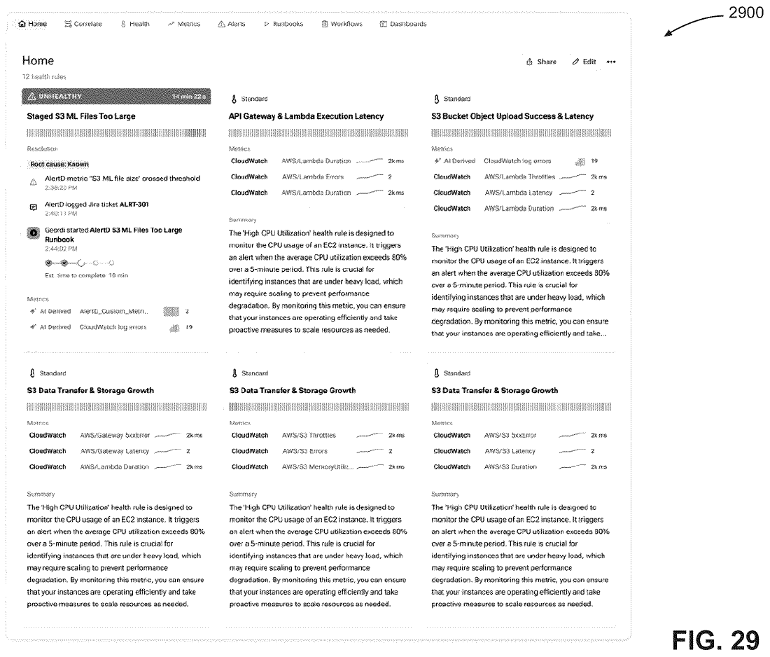

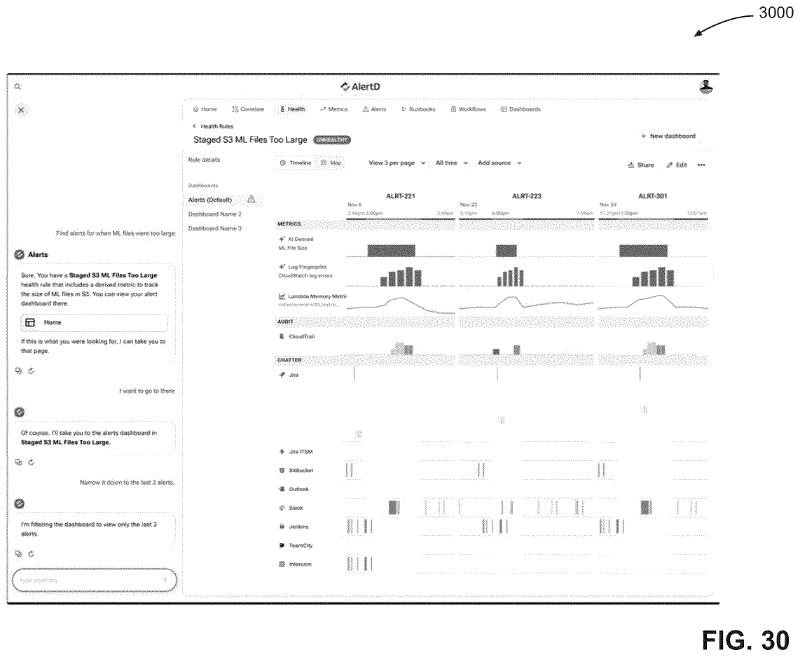

FIG. 29 is a screenshot depicting a health rules overview 2900 showing a runbook in progress. Essentially, health rules overview 2900 is an example of a status view.

### Status View

Runbooks provide insight into a team's progress in resolving an issue. This is useful for stakeholders who wish to get continuous real-time status updates. One aspect includes a user interface that presents to a user a tile marked UNHEALTHY, as depicted in FIG. 29. The tile shows that the runbook has been “started”, it notes who is working on the runbook, it notes the number of steps to resolve the issue, and how many have been completed. It notes that the root cause is known. It notes the estimated time to complete the runbook.

FIG. 30 is a screenshot depicting a design concept for chop time 3000.

### Chop Time

The concept of “Chop Time”, is used to place search results and their correlated MELT and Signals onto the same timeline. The key feature of Chop Time is that unlike a traditional timeline, Chop Time chops out time ranges that are irrelevant. For example, as shown in FIG. 30, the user instructs the AI Agent to “find alerts when ML files were too large”. Three alerts are found, and they are displayed in Chop Time mode.

The systems and methods described herein (e.g., computing system 102) implement an ability to correlate commands (from audit logs) with the outcomes/problems/conditions *caused* by these commands, and to *synthesize* a runbook (e.g., synthesized runbook 2112) allowing an end user to recreate/rerun the set of actual commands or related commands.

Screenshot 2200 shows a combination of an interactive AI-chat. In the past dashboards had to be built by hand. In one aspect of the current invention, a user can just ask our AI “show me something else like HTTP error codes” to modify the fluid dashboard that is shown in FIG. 22. The AlertD system implemented, for example, on computing system 102 moves a user experience from statically built dashboards, to the user never needing to ever build a dashboard manually. Instead, the user can just ask the AI chat to assemble the information they want to see, and the user can be very non-specific about the associated request. In an aspect, the user does not need to know the metrics they want to see, they just need to describe these metrics.

A user interacting with SLDC and other signals may be faced with a signal set that is comprised of over a million such signals. Manually sorting through these signals and/or manually generating a dashboard for each signal set of interest is a daunting task. The systems and methods described herein are configured to receive a user request in a natural language format, process the user request, and generate a custom dashboard that includes the signals of interest to be monitored by the user. This processing and generating may be performed by a system that includes at least one LLM. In an aspect, the user does not have to be specific about the signals of interest; rather, the LLM-based processing can infer user intent and generate a curated set of signals for user review.

The systems and methods described herein thus select relevant signals from a large set of signals such as metrics, logs, events, and traces, and curates the selected signals on a graphical user display that has a limited screen real estate as compared to the set of signals. To provide situational awareness (i.e., whether something is good OR bad), the AlertD system (i.e., computing system 102) selects relevant signals and brings them all together in a way that can tell a story supporting the narrative on the left panel 2002, where the AI tells the user “what is going on”.

In an aspect, dashboard 2200 shows a combination of an interactive AI-chat with a user (e.g., user 104). In the current state-of-the-art, dashboards need to be built by hand. In an aspect described herein, a user can just query an AI component of user computing system 102 (e.g., one or more of the LLMs included in computing system 102) with a message such as “show me something else like HTTP error codes” to modify the fluid dashboard 2200 that is displayed to the user. The systems and methods described herein essentially move the user experience from statically built dashboards, to a user never needing to ever build a dashboard; rather, the user can just ask the AI chat to assemble the information they want to see, and the user can be very non-specific about it. The user does not need to know the names of the metrics they want to see; they just describe them.

Although the present disclosure is described in terms of certain example embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the scope of the present disclosure.

What is claimed is:

1. A method comprising:
receiving a plurality of signals associated with an enterprise system running one or more instances of a software;
analyzing the signals using at least one trained artificial intelligence (AI) model; and
based on the analyzing, presenting:
a situational awareness snapshot to a user regarding a state of a system comprising the computing system and the software; and
a signal triage analysis related to any signals of the plurality of signals that can cause problems with an operation of the system, or are most relevant for the user to comprehend the state of the system.

2. The method of claim 1, wherein the signals include any combination of:
software development lifecycle (SDLC) signals associated with one or more SDLC events;
any combination of one or more logs and one or more events from one or more systems and applications;
one or more command log sets from one or more audit systems; and
one or more metrics from one or more metric systems.

3. The method of claim 2, wherein an SDLC signal is formatted as unstructured or semi-structured text, and the logs, the command logs, and metrics are formatted as any combination of structured text and regular expressions.

4. The method of claim 1, wherein the presenting further comprises dynamically generating a dashboard as a graphical user interface.

5. The method of claim 4, wherein the generating is performed responsive to a user input.

6. The method of claim 5, wherein the user input is a nonspecific input that is processed by using at least one large language model (LLM).

7. The method of claim 4, wherein the generating is dynamic and independent of a predefined template.

8. The method of claim 4, further comprising color-coding any signals displayed on the dashboard.

9. The method of claim 8, wherein the color-coding is dependent on a severity of a health condition associated with one or more signals of the plurality of signals.

10. The method of claim 9, further comprising synthesizing the health condition using one or more AI/LLM systems to analyze the one or more signals, wherein the health condition is a health metric.

11. The method of claim 4, wherein the dashboard is generated based on a resolution of a visual display being used by the user.

12. The method of claim 4, further comprising dynamically regenerating the dashboard in response to an updated user input.

13. The method of claim 1, further comprising:
performing a correlation operation on a subset of signals of the signals with one or more outcomes caused by the signals; and
based on the correlation results, generating a runbook that provides the user with an ability to recreate or run a set of commands, or a set of related commands, associated with generating the subset of signals.

14. The method of claim 1, further comprising presenting a calendar graphical user interface to the user, wherein the calendar graphical user interface includes a selection of any combination of one or more events or one or more metric aggregations.

15. The method of claim 14, wherein the selection is performed by the AI model.

16. An apparatus comprising:
a computing system;
a computer network; and
a plurality of data source systems connected to the computing system via the computer network, wherein the computing system is configured to:
receive a plurality of signals associated with another computing system running one or more instances of a software, from the data source systems via the computer network;
analyze the signals using at least one trained artificial intelligence (AI) model; and
based on the analyzing, present:
a situational awareness snapshot to a user regarding a state of a system comprising the other computing system and the software; and
a signal triage analysis related to any signals of the plurality of signals that can cause problems with an operation of the system, or are most relevant for the user to comprehend the state of the system.

17. The apparatus of claim 16, wherein the signals include any combination of:
software development lifecycle (SDLC) signals associated with one or more SDLC events;
any combination of one or more logs and one or more events from one or more systems and applications; one or more command log sets from one or more audit systems; and
one or more metrics from one or more metric systems.

18. The apparatus of claim 17, wherein an SDLC signal is formatted as unstructured or semi-structured text, and the logs, the command logs, and metrics are formatted as any combination of structured text and regular expressions.

19. The apparatus of claim 16, wherein the presenting further comprises the computing system dynamically generating a dashboard as a graphical user interface.

20. The apparatus of claim 19, wherein the generating is performed responsive to a user input.

21. The apparatus of claim 20, wherein the user input is a nonspecific input that is processed by using at least one large language model (LLM).

22. The apparatus of claim 19, wherein the generating is dynamic and independent of a predefined template.

23. The apparatus of claim 19, further comprising the computing system color-coding any signals displayed on the dashboard.

24. The apparatus of claim 23, wherein the color-coding is dependent on a severity of a health condition associated with one or more signals of the plurality of signals.

25. The apparatus of claim 24, further comprising synthesizing the health condition using one or more AI/LLM systems to analyze the one or more signals, wherein the health condition is a health metric.

26. The apparatus of claim 19, wherein the dashboard is generated based on a resolution of a visual display being used by the user.

27. The apparatus of claim 19, further comprising the computing system dynamically regenerating the dashboard in response to an updated user input.

28. The apparatus of claim 16, further comprising the computing system:
performing a correlation operation on a subset of signals of the signals with one or more outcomes caused by the signals; and
based on the correlation results, generating a runbook that provides the user with an ability to recreate or run a set of commands, or a set of related commands, associated with generating the subset of signals.

29. The apparatus of claim 16, wherein the computing system is configured to present a calendar graphical user interface to the user, wherein the calendar graphical user interface includes a selection of any combination of one or more events or one or more metric aggregations.

30. The apparatus of claim 29, wherein the selection is performed by the AI model.

31. A non-transitory computer-readable medium storing executable code that, when executed on a computing system, causes the computing system to perform:
receiving a plurality of signals associated with another computing system running one or more instances of a software;
analyzing the signals using at least one trained artificial intelligence model; and
based on the analyzing, presenting:
a situational awareness snapshot to a user regarding a state of a system comprising the other computing system and the software; and
a signal triage analysis related to any signals of the plurality of signals that can cause problems with an operation of the system, or are most relevant for the user to comprehend the state of the system.
